(19) United States
(12) Patent Application Publication
(10) Pub. No.: US 2007/0166082 A1
(43) Pub. Date: Jul. 19, 2007

(54) Transfer position controlling apparatus, image forming device having the same and transfer position controlling method thereof

(75) Inventor: Sung-tack Byun, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/642,842

(22) Filed: Dec. 21, 2006

(30) Foreign Application Priority Data
Jan. 13, 2006 (KR) 2006-004037

(51) Int. Cl. G03G 15/01

(52) U.S. Cl. 399/301

(57) ABSTRACT

A transfer position controlling apparatus of an image forming device includes an encoding part having a plurality of first encoding elements formed in a longitudinally spaced apart relation on a transfer belt, a sensing part having a first detecting sensor to detect the plurality of first encoding elements, the sensing part being disposed on a moving path which the plurality of first encoding elements move when the transfer belt rotates, and a controller to determine a transfer start position at which a developer image is transferred to the transfer belt, on the basis of a detection signal generated by the first detecting sensor when the first detecting sensor first detects one of the plurality of first encoding elements after a printing command is input, and to control the device to form a developer image on the photoconductor according to the determined transfer start position. The apparatus can form a plurality of developer images, particularly, a first developer image on the photoconductor as soon as the first detecting sensor detects the first encoding elements after the printing command is input. Accordingly, standby time for forming the first developer image on the photoconductor is reduced, so that printing time is not delayed or irregular.

### CROSS-REFERENCE TO RELATED APPLICATION

This application claims the benefit under 35 U.S.C. § 119(a) of Korean Patent Application No. 10-2006-004037 filed Jan. 13, 2006, in the Korean Intellectual Property Office, the entire disclosure of which is hereby incorporated by reference.

### BACKGROUND OF THE INVENTION

1. Field of the Invention

The present invention relates to an image forming apparatus, such as a copier or a laser printer. More particularly, the present invention relates to a transfer position controlling apparatus to control a transfer position at which a developer image is transferred to a transfer belt, an image forming device having the transfer position controlling apparatus and a transfer position controlling method thereof.

2. Description of the Related Art

Color image forming apparatuses are typically classified as either a multi-path type apparatus or a single path type apparatus. A multi-path type apparatus rotates a single photoconductor several times to form a desired color image, and a single path type apparatus rotates a plurality of photoconductors one time to form a desired color image.

A multi-path type image forming device usually has a transfer belt that puts a plurality of single color developer images, for example, yellow, magenta, cyan, and black developer images, formed at predetermined time intervals on a photoconductor together to form a primary transfer image, and then transfers the primary transfer image to an image receiving medium.

The plurality of single color developer images are individually formed on the photoconductor by corresponding developing units, and then transferred and superimposed on the transfer belt. Accordingly, to produce a uniform primary transfer image in which there are no variations in color tone among the color developer images, when the respective single color developer images formed on the photoconductor are transferred and superimposed on the transfer belt, it is necessary to precisely control the transfer start positions at which the respective color developer images are transferred to the transfer belt.

FIG. 1 shows a conventional multi-path type color image forming device 1 having a transfer position detecting apparatus 10 to detect a transfer start position, at which a plurality of single color developer images individually formed on a photoconductor are transferred to a transfer belt 15.

As shown in FIG. 4, the transfer position detecting apparatus 10 includes a position detecting hole 11 formed on the transfer belt 15, and a detecting sensor 30 having a light emitting part and a light receiving part disposed opposite to the position detecting hole 11 on a moving path of the position detecting hole 11.

As shown in FIGS. 2 and 3, the position detecting hole 11 penetrates a photoconductive layer 17 and a protective layer 20 of the transfer belt 15 at a side of the transfer belt 15. The position of the detecting hole 11 corresponds to a predetermined transfer start position.

The operation of the conventional image forming device 1 having the transfer position detecting apparatus 10 constructed as described above will now be described.

When a printing command is input from an external device such as a computer, the transfer belt 15 begins to rotate, and the detecting sensor 30 generates a detection signal when the position detecting hole 11 formed at the predetermined transfer start position of the transfer belt 15 is detected.

When the detecting sensor 30 generates the detection signal, a controller (not shown) determines the position of the transfer belt 15 corresponding to the position detecting hole 11 with a transfer start position for a first color developer image, for example, a yellow developer image, and controls a laser scanning unit (LSU) 76 and a yellow developing unit 34 to form a yellow developer image at a position of the photoconductor 32 corresponding to the position of the transfer belt 15 determined as the transfer start position for the yellow developer image.

As a result, the LSU 76 forms a yellow electrostatic latent image for the yellow developer image on the photoconductor 32 by emitting laser beams according to image signals input from the external device, and a developing roller 47 of the yellow developing unit 34 applies a yellow developer on the yellow electrostatic latent image formed on the photoconductor 32 while being rotated with the photoconductor 32 so as to develop the yellow electrostatic latent image into a yellow developer image.

Subsequently, when the position of the transfer belt 15 determined as the transfer start position for the yellow developer image arrives at a first transfer nip between the transfer belt 15 and the photoconductor 32, first transfer rollers 48 are applied with a first transfer-bias voltage having a predetermined electric potential and a polarity opposite to that of the developer. As a result, the yellow developer image formed on the photoconductor 32 is transferred to the transfer belt 15 by the first transfer-bias voltage and pressure from the first transfer rollers 48.

After the yellow developer image is transferred to the transfer belt 15, used yellow developer remaining on the photoconductor 32 is removed by a photoconductor cleaning member (not shown), which is able to be placed into contact with or be separated from the photoconductor 32 by the operation of an actuating member (not shown).

When the detecting sensor 30 generates another detection signal due to the position detecting hole 11, a second color developer image, for example, a magenta developer image, is formed on the photoconductor 32 by the LSU 76 and a magenta developing unit 35 in the same manner as that of the yellow developer image. And then, when the transfer start position of the transfer belt 15, that is, the same position as that of the transfer belt 15 determined as the transfer start position for the yellow developer image arrives at the first transfer nip, the magenta developer image formed on the photoconductor 32 is transferred and superimposed upon the yellow developer image of the transfer belt 15 by the first transfer-bias voltage and the pressure from the first transfer rollers 48.

In the same manner, third and fourth developer images, for example, cyan and black developer images, are individually formed on the photoconductor 32 by the LSU 76 and cyan and black developing units 36 and 37, and then transferred and superimposed upon the yellow and the magenta developer images of the transfer belt 15. As a result, a primary transfer image to be transferred to an image receiving medium P is formed on the transfer belt 15.

When an image receiving medium P picked up by a pickup roller 21 arrives at a second transfer nip between the transfer belt 15 and a second transfer roller 49, the second transfer roller 49 is applied with a second transfer-bias voltage having a predetermined electric potential and a polarity opposite to that of the developer. As a result, the primary transfer image formed on the transfer belt 15 is secondarily transferred to the image receiving medium P by the second transfer-bias voltage and pressure from the second transfer roller 49 to form a secondary transfer image thereon.

The secondary transfer image formed on the image receiving medium P is fused onto the image receiving medium P by a heating roller 51 and a compression roller 52 constituting a fusing unit 50, and then discharged by a discharge roller 61 and a backup roller 62 of a discharging unit 60.

According to the conventional image forming device 1 constructed as described above, the transfer start position of the transfer belt 15 for respective developer images is determined on the basis of the detection signal generated by the detecting sensor 30 when the detecting sensor 30 detects the single position detecting hole 11. Therefore, during printing, a transfer start time which the respective developer images, particularly, the first color developer image begin to be transferred to the transfer belt 15 is affected by the position of the position detecting hole 11 of the transfer belt 15 when the printing command is input. Accordingly, every time printing occurs, the transfer start time for the first color developer image varies, so that the printing time is delayed or becomes irregular.

More specifically, the latent image forming time (that is, the time that the latent image for a first color developer image, for example, a yellow developer image, begins to be formed on the photoconductor 32 by the LSU 76 after a printing command is input) is determined with respect to the time when the detecting sensor 30 generates a detection signal with respect to the position detecting hole 11. Also, the transfer start time (that is, the time that the yellow developer image formed on the photoconductor 32 begins to be transferred) is determined as a time after a predetermined amount of time has elapsed from a time when the detecting sensor 30 generates the detection signal. The predetermined amount of time corresponds to a time interval during which a transfer start position of the transfer belt 15 for a yellow developer image arrives at the first transfer nip between the transfer belt 15 and the photoconductor 32.

Therefore, even though the printing command is input, the LSU 76 does not immediately form a yellow electrostatic latent image, but waits until the detecting sensor 30 generates a detection signal with respect to the position detecting hole 11.

Accordingly, assuming that a period for one rotation of the transfer belt 15 is 3 seconds, a standby time for forming the yellow electrostatic latent image is between zero (0) and three (3) seconds. Therefore, the latent image forming time may be irregular and may be delayed by up to three (3) seconds.

To prevent the times from being irregular or delayed, a method that physically deduces the length of the transfer belt 15 and thus reduces the period for one rotation of the transfer belt 15 can be considered. The length of the transfer belt 15, however, is determined on the basis of the length of the maximum size of the image receiving medium P which is printable by the image forming device 1. Accordingly, it is impossible to physically reduce the length of the transfer belt 15.

Further, with the conventional image forming device 1, the transfer start position for respective developer images is always fixed to a certain position of the transfer belt 15 at which the single position detecting hole 11 is located, since it is determined on the basis of the detection signal generated by the detecting sensor 30 when the detecting sensor 30 detects the position detecting hole 11. Accordingly, the portion of the transfer belt which corresponds to the most frequently used size of image receiving medium P is frequently used, but the remaining portion of the transfer belt is infrequently used. Thus, when first and second transfer-bias voltages and pressure are applied to the transfer belt 14 from the first and the second transfer rollers 48 and 49 during the transferring operations, they are repeatedly imposed only on a portion of the transfer belt 15 within the most frequently used range. As a result, the lifespan of the transfer belt 136 is reduced.

Also, with the conventional image forming device 1, the controller determines whether the detecting sensor 30 generates a detection signal every detection signal generating period of the detecting sensor 30, that is, the period for one rotation of the transfer belt 15. If the signal is not generated, the controller determines that the transfer belt 15 is in an abnormal condition and stops driving of the transfer belt 15. Accordingly, if the transfer belt 15 has an operational issue, it takes between zero (0) and three (3) seconds until it is determined that the transfer belt 15 is in an abnormal condition. Thus, even though the transfer belt 15 causes a fault, it may rotate for up to three (3) seconds before the fault is detected. As a result, the chances of causing damage, such as a split in the transfer belt 15, is increased.

Accordingly, there is a need for an improved transfer position controlling apparatus that regulates and reduces transfer start time, thereby preventing printing time from being delayed or irregular and helping to prevent damage to the transfer belt.

### SUMMARY OF THE INVENTION

An aspect of the present invention is to address at least the above problems and/or disadvantages and to provide at least the advantages described below. Accordingly, an aspect of the present invention is to provide a transfer position controlling apparatus that regulates and reduces a transfer start time, thereby preventing printing time from being delayed or irregular, an image forming device having the same and a transfer position controlling method thereof.

Another aspect of the present invention is to provide a transfer position controlling apparatus that evenly uses the whole transfer belt, thereby extending the lifespan of the transfer belt, an image forming device having the same and a transfer position controlling method thereof.

Still another aspect of the present invention is to provide a transfer position controlling apparatus that reduces the period for checking or detecting the condition of the transfer belt, thereby preventing the transfer belt from being damaged as a result of delayed detection of abnormal condition of the transfer belt.

According to an aspect of an exemplary embodiment of the present invention, a transfer position controlling apparatus of an image forming device includes an encoding part having a plurality of first encoding elements formed in a longitudinally spaced apart relation on a transfer belt, a sensing part having a first detecting sensor to detect the plurality of first encoding elements, the sensing part being disposed on a moving path which the plurality of first encoding elements move when the transfer belt rotates, and a controller to determine a transfer start position at which a developer image is transferred to the transfer belt, on the basis of a detection signal generated by the first detecting sensor when the first detecting sensor first detects one of the plurality of first encoding elements after a printing command is input, and to control the device to form a developer image on the photoconductor according to the determined transfer start position.

The plurality of first encoding elements may comprise one of a plurality of first slits or holes formed to penetrate the transfer belt, the plurality of first slits or holes being spaced apart from one another along one side of the transfer belt, a plurality of first reflecting surfaces formed to be spaced apart from one another along one side of a surface of the transfer belt, and a plurality of first toothed openings formed to be spaced apart from one another along one side of the transfer belt.

The first detecting sensor may comprise a first photo-interrupt sensor having a first light emitting part and a first light receiving part.

The controller may control the image forming apparatus so that images on the transfer belt are superimposed upon one another. For this, the controller may determine as a transfer start position for the first developer image, a position of the transfer belt corresponding to a first encoding element detected after the printing command is input, and determine as transfer start positions for the remaining developer images, respectively, positions of the transfer belt corresponding to first encoding elements detected after a transfer control period C passes from a time when the first detecting sensor first generates the detection signal after the printing command is input. The transfer control period C is calculated according to the following equation:

C=X±M′,

where X is a period for one rotation of the transfer belt, and M′ is a predetermined second control margin.

Also, the controller may determine whether the first detecting sensor generates a detection signal every predetermined period D for detecting abnormal condition of the transfer belt, and stop the transfer belt when the first detecting sensor does not generate the detection signal. The predetermined period D for detecting abnormal condition of the transfer belt may comprise a detection signal generating period T of the first detecting sensor, which is calculated according to the following equation:

T=X/N±M,

where, X is a period for one rotation of the transfer belt, N is the number of the first encoding elements, and M is a predetermined first control margin.

Alternatively, the encoding part may further comprise a second encoding element formed on the transfer belt to have a moving path separate from the moving path of the first encoding elements, and the sensing part may further comprise a second detection sensor disposed on the moving path of the second encoding element to detect the second encoding element.

At this time, the second encoding element may comprise one of a second slit or hole formed to penetrate the transfer belt at the other side of the transfer belt, a second reflecting surface formed at the other side of the surface of the transfer belt, and a second toothed opening formed at the other side of the transfer belt, wherein the second detecting sensor comprises a second photo-interrupt sensor having a second light emitting part and a second light receiving part.

In this case, if the controller superimposes a plurality of developer images on the transfer belt, it may count the number of detection signals generated by the first detecting sensor from a time when the second detecting sensor generates a detection signal through a time when the printing command is input, so as to store the counted number of detection signals as a reference number of detection signals for determining a transfer position, determine as a transfer start position for the first developer image a position of the transfer belt corresponding to a first encoding element detected when the printing command is input, and count a number of detection signals generated by the first detecting sensor from a time when the second detecting sensor again generates a detection signal, so as to determine as transfer start positions for the remaining developer images, respectively, positions of the transfer belt corresponding to first encoding elements detected when the counted number of detection signals reaches the reference number of detection signals.

Alternatively, at this time, the controller may determines whether the position of the transfer belt determined as the transfer start position for the first developer image overlaps with the position of the transfer belt in previous printing, and, if the determined position of the transfer belt overlaps the position of the transfer belt in the previous printing, determines as a transfer start position for the first developer image a position of the transfer belt corresponding to a first encoding element detected after a lapse of a predetermined number of the detection signals from the time when the printing command is input.

The controller may determine which of a plurality of regions of the transfer belt the position of the transfer belt determined as the transfer start position for the first developer image is located, on the basis of the number of detection signals generated by the first detecting sensor counted from the time when the second detecting element is detected through the time when the printing command is input, determine whether the region of the transfer belt determined as the transfer start position for the first developer image overlaps the region previously printed, and, if the determined region of the transfer belt overlaps the previous printing, determine as a transfer start position for the first developer image a position of the transfer belt corresponding to a first encoding element detected after a lapse of predetermined number of the detection signals until the determined region of the transfer belt is changed to another region. At this time, the reference number of detection signals for determining transfer position may comprise a number of detection signals which adds the predetermined number of the detection signals and the number of detection signals generated by the first detecting sensor counted from the time when the second detecting element is detected to the time when the printing command is input. Also, at this time, the controller may adjust the predetermined number of the detection signals so as to successively use the plurality of regions of the transfer belt according to a predetermined order.

According to another aspect of an exemplary embodiment of the present invention, an image forming device includes a photoconductor for forming a developer image, a transfer belt for transferring the developer image from the photoconductor to the transfer belt, a transfer position controlling unit to control a transfer position at which the developer image is transferred to the transfer belt. The transfer position controlling unit comprises an encoding part having a plurality of first encoding elements formed in a longitudinally spaced apart relation on a transfer belt, a sensing part having a first detecting sensor to detect the plurality of first encoding elements, the sensing part being disposed on a moving path which the plurality of first encoding elements move when the transfer belt rotates, and a controller to determine a transfer start position at which a developer image is transferred to the transfer belt, on the basis of a detection signal generated by the first detecting sensor when the first detecting sensor first detects one of the plurality of first encoding elements after a printing command is input, and to control the device to form a developer image on the photoconductor according to the determined transfer start position.

The plurality of first encoding elements may comprise one of a plurality of first slits or holes formed to penetrate the transfer belt, the plurality of first slits or holes being spaced apart from one another along one side of the transfer belt, a plurality of first reflecting surfaces formed to be spaced apart from one another along one side of a surface of the transfer belt, and a plurality of first toothed openings formed to be spaced apart from one another along one side of the transfer belt.

The first detecting sensor may comprise a first photo-interrupt sensor having a first light emitting part and a first light receiving part.

The controller may control the image forming apparatus so that images on the transfer belt are superimposed upon one another. For this, the controller may determine as a transfer start position for the first developer image, a position of the transfer belt corresponding to a first encoding element detected after the printing command is input, and determine as transfer start positions for the remaining developer images, respectively, positions of the transfer belt corresponding to first encoding elements detected after a transfer control period C passes from a time when the first detecting sensor first generates the detection signal after the printing command is input. The transfer control period C is calculated according to the following equation:

C=X±M′,

where X is a period for one rotation of the transfer belt, and M′ is a predetermined second control margin.

Also, the controller may determine whether the first detecting sensor generates a detection signal every predetermined period D for detecting abnormal condition of the transfer belt, and stop the transfer belt when the first detecting sensor does not generate the detection signal. The predetermined period D for detecting abnormal condition of the transfer belt may comprise a detection signal generating period T of the first detecting sensor, which is calculated according to the following equation:

T=X/N±M,

where, X is a period for one rotation of the transfer belt, N is the number of the first encoding elements, and M is a predetermined first control margin.

Alternatively, the encoding part may further comprise a second encoding element formed on the transfer belt to have a moving path separate from the moving path of the first encoding elements, and the sensing part may further comprise a second detection sensor disposed on the moving path of the second encoding element to detect the second encoding element.

At this time, the second encoding element may comprise one of a second slit or hole formed to penetrate the transfer belt at the other side of the transfer belt, a second reflecting surface formed at the other side of the surface of the transfer belt, and a second toothed opening formed at the other side of the transfer belt, wherein the second detecting sensor comprises a second photo-interrupt sensor having a second light emitting part and a second light receiving part.

In this case, if the controller superimposes a plurality of developer images on the transfer belt, it may count the number of detection signals generated by the first detecting sensor from a time when the second detecting sensor generates a detection signal through a time when the printing command is input, so as to store the counted number of detection signals as a reference number of detection signals for determining a transfer position, determine as a transfer start position for the first developer image a position of the transfer belt corresponding to a first encoding element detected when the printing command is input, and count a number of detection signals generated by the first detecting sensor from a time when the second detecting sensor again generates a detection signal, so as to determine as transfer start positions for the remaining developer images, respectively, positions of the transfer belt corresponding to first encoding elements detected when the counted number of detection signals reaches the reference number of detection signals.

Alternatively, at this time, the controller may determine whether the position of the transfer belt determined as the transfer start position for the first developer image overlaps with the position of the transfer belt in previous printing, and, if the determined position of the transfer belt overlaps the position of the transfer belt in the previous printing, determine as a transfer start position for the first developer image a position of the transfer belt corresponding to a first encoding element detected after a lapse of a predetermined number of the detection signals from the time when the printing command is input.

The controller may determine which of a plurality of regions of the transfer belt the position of the transfer belt determined as the transfer start position for the first developer image is located, on the basis of the number of detection signals generated by the first detecting sensor counted from the time when the second detecting element is detected through the time when the printing command is input, determine whether the region of the transfer belt determined as the transfer start position for the first developer image overlaps the region previously printed, and, if the determined region of the transfer belt overlaps the previous printing, determine as a transfer start position for the first developer image a position of the transfer belt corresponding to a first encoding element detected after a lapse of predetermined number of the detection signals until the determined region of the transfer belt is changed to another region. At this time, the reference number of detection signals for determining transfer position may comprise a number of detection signals which adds the predetermined number of the detection signals and the number of detection signals generated by the first detecting sensor counted from the time when the second detecting element is detected to the time when the printing command is input. Also, at this time, the controller may adjust the predetermined number of the detection signals so as to successively use the plurality of regions of the transfer belt according to a predetermined order.

According to still another aspect of an exemplary embodiment of the present invention, a method of controlling a transfer position of an image forming device comprises the steps of detecting a plurality of first encoding elements formed on a transfer belt by a first detecting sensor when a printing command is input, and controlling a transfer start position at which a developer image is transferred to the transfer belt on the basis of a time when the first detecting sensor first generates a detection signal with one of the plurality of the first encoding elements after the printing command is input.

The controlling the transfer start position may comprise the step of determining the transfer start position at which the developer image is transferred to the transfer belt, on the basis of a detection signal generated by the first detecting sensor when the first detecting sensor first detects one of the plurality of the first encoding elements after the printing command is input, beginning to form a developer image at an image forming position of the photoconductor corresponding to the determined transfer start position of the transfer belt, and transferring the developer image formed on the photoconductor to the transfer belt when the determined transfer start position of the transfer belt arrives at the photoconductor.

If a plurality of developer images are overlapped on the transfer belt, the determining the transfer start position may comprise the steps of determining as a transfer start position for the first developer image, a position of the transfer belt corresponding to a first encoding element detected after the printing command is input, and determining as transfer start positions for the remaining developer images, respectively, positions of the transfer belt corresponding to first encoding elements detected when a transfer control period C calculated according to the following equation passes from a time when the first detecting sensor first generates the detection signal after the printing command is input:

C=X±M′

where, X is a period for one rotation of the transfer belt, and M′ is a predetermined second control margin.

Also, the transfer position controlling method of the invention may further comprise the step of determining whether the transfer belt is in a normal condition.

The step of determining whether the transfer belt is in a normal condition may comprise determining whether the first detecting sensor generates a detection signal every predetermined period D for detecting abnormal condition of the transfer belt, and stopping the transfer belt if the first detecting sensor does not generate the detection signal. The predetermined period D for detecting abnormal condition of the transfer belt may comprise a detection signal generating period T of the first detecting sensor calculated according to the following equation:

T=X/N±M,

where, X is a period for one rotation of the transfer belt, N is a number of the first encoding elements, and M is a predetermined first control margin.

According to yet another aspect of an exemplary embodiment of the present invention, a method of controlling a transfer position of an image forming device comprises the steps of initiating the image forming device, detecting a second encoding element formed on a transfer belt with a second detecting sensor while initiating the image forming device, counting a number of detection signals generated by a first detecting sensor when the first detecting sensor detects a plurality of first encoding elements formed on the transfer belt, from a time when the second detecting element is detected, determining whether a printing command is input, controlling a transfer start position at which a first developer image of a plurality of developer images is transferred to the transfer belt, on the basis of a position of the transfer belt corresponding to a first encoding element detected after the printing command is input, and controlling transfer start positions which the remaining developer images of the plurality of developer images are transferred to the transfer belt, on the basis of the number of detection signals generated by the first detecting sensor counted from the time when the second detecting element is detected through the time when the printing command is input.

The step of initiating the image forming device may comprise rotating the transfer belt.

The step of counting the number of detection signals may comprise resetting a number of detection signals when the second detecting element is detected, and counting the detection signals generated by the first detecting sensor.

The step of controlling the transfer start position for the first developer image may comprise determining as a transfer start position at which a first developer image is transferred to the transfer belt a position of the transfer belt corresponding to a first encoding element detected when the printing command is input, forming a first developer image from an image forming position of the photoconductor corresponding to the determined position of the transfer belt, and transferring the first developer image formed on the photoconductor to the transfer belt when the determined position of the transfer belt arrives at the photoconductor.

The step of controlling transfer start positions for the remaining developer images may comprise storing as a reference number of detection signals for determining transfer position the number of detection signals generated by the first detecting sensor counted from the time when the second detecting element is detected through the time when the printing command is input, counting again a number of detection signals generated by the first detecting sensor from a time when the second detecting sensor generates a detection signal, determining as the transfer start positions which the remaining developer images are transferred to the transfer belt, respectively, positions of the transfer belt corresponding to first encoding elements detected when the counted number of detection signals reaches the stored reference number of detection signals, forming the remaining developer images from image forming positions of the photoconductor corresponding to the determined positions of the transfer belt, respectively, and transferring the remaining developer images formed on the photoconductor to the transfer belt when the determined positions of the transfer belt arrive at the photoconductor, respectively.

Alternatively, the step of determining as the transfer start position at which the first developer image is transferred to the transfer belt may comprise determining whether the position of the transfer belt determined as the transfer start position for the first developer image is overlaps the position used in a previous printing, and, if the determined position of the transfer belt overlaps the previous printing, determining as the transfer start position for the first developer image a position of the transfer belt corresponding to a first encoding element detected after a lapse of predetermined number of the detection signals from the time when the printing command is input.

In this case, the step of determining whether the position of the transfer belt determined as the transfer start position for the first developer image is overlapped may comprise determining which of a plurality of regions of the transfer belt the position of the transfer belt determined as the transfer start position for the first developer image is located, on the basis of the number of detection signals generated by the first detecting sensor counted from the time when the second detecting element is detected to the time when the printing command is input, and determining whether the region of the transfer belt determined that the position of the transfer belt determined as the transfer start position for the first developer image is located overlaps the region used in the previous printing. At this time, the predetermined number of the detection signals may comprise a number of detection signals generated by the first detecting sensor until the determined region of the transfer belt is changed to another region, and the reference number of detection signals for determining a transfer position may comprise a number of detection signals which adds the predetermined number of the detection signals and the number of detection signals generated by the first detecting sensor counted from the time when the second detecting element is detected to the time when the printing command is input.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic cross-sectional view of a conventional color image forming device;

FIG. 2 is a partial top plan view of a position detecting hole of a transfer position detecting apparatus, which is formed on a transfer belt of the color image forming device of FIG. 1;

FIG. 3 is a partial cross-sectional view of the position detecting hole of FIG. 2;

FIG. 4 is a partial side elevation view of the transfer position detecting apparatus of the color image forming device of FIG. 1;

FIG. 5 is a schematic cross-sectional view of a color laser printer having a transfer position controlling unit according to a first exemplary embodiment of the present invention;

FIG. 6 is a partial top plan view of an encoding part of the transfer position controlling unit, which is formed on a transfer belt of the color laser printer of FIG. 5; and

FIG. 7 is a partial side elevation view of the encoding part and a sensing part of the transfer position controlling unit of the color laser printer of FIG. 5;

FIGS. 8A and 8B are a partial top plan view and a partial side elevation view, respectively, of another example of the encoding part and the sensing part of the transfer position controlling unit of the color laser printer of FIGS. 6 and 7;

FIGS. 9A and 9B are a partial top plan view and a partial side elevation view, respectively, of yet another example of the encoding part and the sensing part of the transfer position controlling unit of the color laser printer of FIGS. 6 and 7;

FIG. 10 is a flow chart of the printing process of the color laser printer having the transfer position controlling unit of FIG. 5;

FIG. 11 is a schematic cross-sectional view of a color laser printer having a transfer position controlling unit according to a second exemplary embodiment of the present invention;

FIG. 12 is a partial top plan view of an encoding part of the transfer position controlling unit, which is formed on a transfer belt of the color laser printer of FIG. 11; and

FIG. 13 is a partial side elevation view of the encoding part and a sensing part of the transfer position controlling unit of the color laser printer of FIG. 11;

FIGS. 14A and 14B are a partial top plan view and a partial side elevation view, respectively, of another example of the encoding part and the sensing part of the transfer position controlling unit of the color laser printer of FIGS. 12 and 13;

FIGS. 15A and 15B are a partial top plan view and a partial side elevation view, respectively, of yet another example of the encoding part and the sensing part of the transfer position controlling unit of the color laser printer of FIGS. 12 and 13;

FIG. 16 is a flow chart of the printing process of the color laser printer having the transfer position controlling unit of FIG. 11; and

FIG. 17 is a flow chart of another example of a transfer start position determining step of the printing process of the color laser printer of FIG. 17.

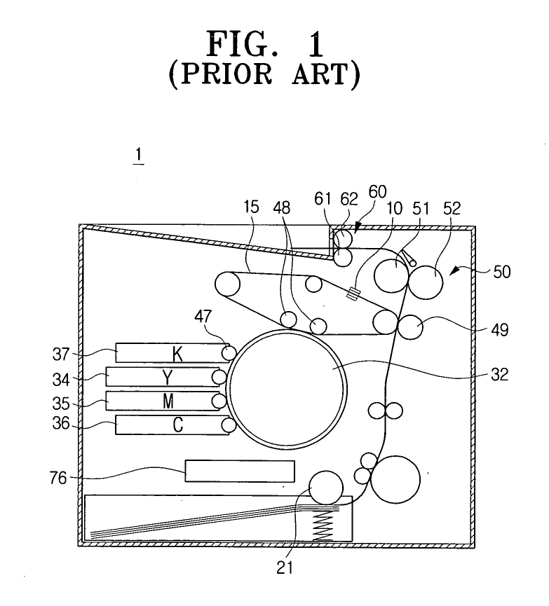

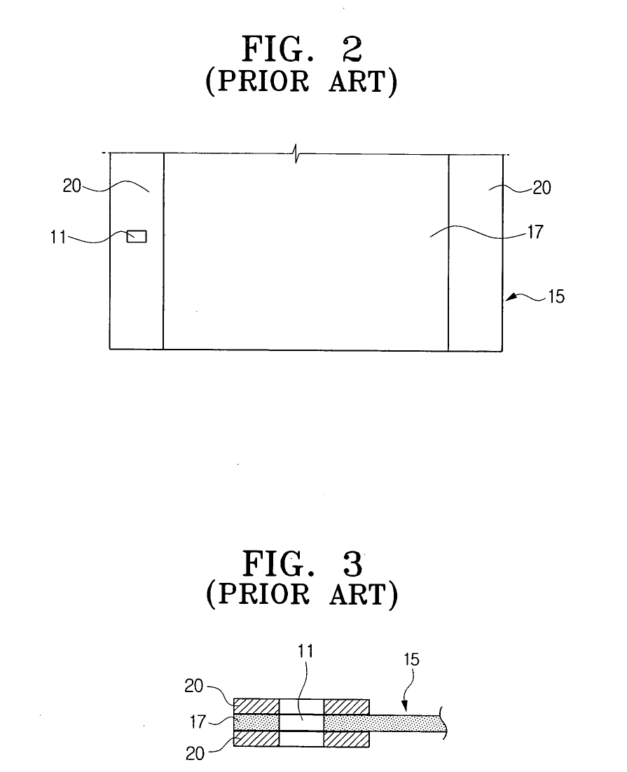

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

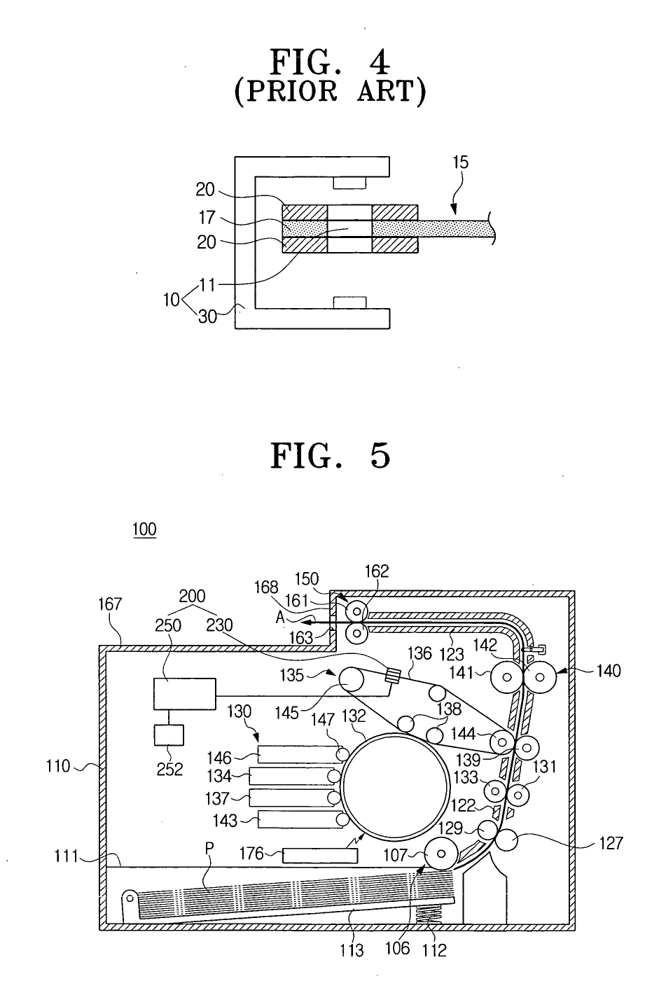

FIG. 5 schematically shows an image forming device having a transfer position controlling apparatus according to a first exemplary embodiment of the present invention.

The image forming device having the transfer position controlling apparatus according to the first exemplary embodiment of the present invention may be a color laser printer 100 that prints and outputs data input from an external device, such as a computer. The present invention is not limited to the color laser printer 100, however, and may be used with other image forming apparatuses.

The color laser printer 100 includes a medium cassette 111, a feeding unit 106, an image forming unit 130, a transferring unit 135, a transfer position controlling unit 200, a fusing unit 140, and a discharging unit 150.

The medium cassette 111 is detachably installed at a bottom portion of a main body frame 110, and has a pressing plate 113 supported by a resilient spring 112 to resiliently raise and lower an image receiving medium P such as a paper.

The feeding unit 106 is disposed above the medium cassette 111 to pick up and feed the image receiving medium P loaded in the medium cassette 111 one by one. The feeding unit 106 includes a medium sensor (not shown) to detect whether the image receiving medium P is loaded in the medium cassette 111, a first pickup roller 107 to pick up the image receiving medium P loaded in the medium cassette 111, and first and second conveying rollers 127 and 131 and first and second backup rollers 129 and 133 to convey the picked-up image receiving medium P along a conveying guide frame 122 that forms a medium conveying and discharging path A.

The image forming unit 130 is provided with a photoconductor 132, which is continuously rotated in one direction, for example, in a clockwise direction, by a photoconductor driving source (not shown) such as a motor.

A charger (not shown), a laser scanning unit LSU 176, four, (for example, yellow, magenta, cyan and black) developing units 134, 137, 143 and 146, and the transferring unit 135 are arranged at predetermined locations around an outer circumference of the photoconductor 132. The yellow, magenta, cyan and black developing units 134, 137, 143 and 146 contain developers of corresponding colors, that is, yellow, magenta, cyan and black, respectively.

The charger may be a scorotron charger which uniformly charges an outer surface of the photoconductor 132 to a certain electric potential. After the photoconductor is charged, the LSU 176 scans the outer surface of the photoconductor 132, by laser beams emitted from a light source such as a laser diode according to an image signal input from an external device (such as a computer), and thereby forms an electrostatic latent image on the outer surface of the photoconductor 132.

Each of the yellow, magenta, cyan and black developing units 134, 137, 143 and 146 includes a developing roller 147, a developer supplying roller (not shown), and a developer layer regulating member or blade (not shown). The developing roller 147 applies a corresponding developer on a corresponding electrostatic latent image formed on the photoconductor 132 while being rotated with the photoconductor 132 so as to develop the electrostatic latent image into a developer image. The developing roller 147 is opposite to, and spaced apart from, the photoconductor 132 by a gap, for example, 0.2 mm. The developer supplying roller supplies the developer to the developer roller 147 using an electric potential difference from the developer roller 147. The developer layer regulating blade regulates the developer supplied to the developing roller 147 through the developer supplying roller such that a film formed on the developing roller 147 has a predetermined thickness.

The transferring unit 135 electrostatically transfers the developer image formed on the outer surface of the photoconductor 132 to the image receiving medium P, and includes a transfer belt 136, and first and second transfer rollers 138 and 139.

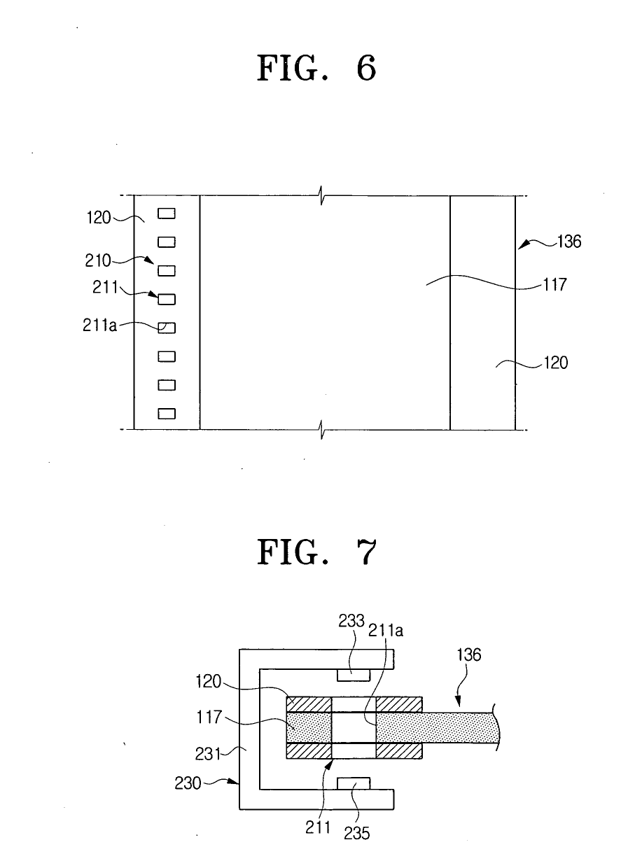

As shown in FIGS. 6 and 7, the transfer belt 136 has a photoconductive layer 117 made of a polymer having a volume resistance of 10⁸ Ω·cm˜10¹¹ Ω·cm to enhance a transfer efficiency, and a protective layer 120 formed along both sides of the photoconductive layer 117. In order to prevent an image spreading, a high resistance coating layer having a volume resistance higher than 10⁸ Ω·cm˜10¹¹ Ω·cm is formed on an outer surface of the photoconductive layer 117.

The transfer belt 136 is rotatably supported by a driving roller 144 and a driven roller 145.

The first transfer rollers 138 are connected to a first transfer-bias voltage applying unit (not shown) so as to apply a predetermined first transfer-bias voltage having a polarity opposite to that of the developer to the transfer belt 136. The first transfer rollers 138 apply the predetermined first transfer-voltage to the transfer belt 136, so that the developer images formed on the surface of the photoconductor 132 can be individually transferred and superimposed upon the transfer belt 136 to form a primary transfer image.

The second transfer roller 139 is connected to a second transfer-bias voltage applying unit (not shown) so as to apply a predetermined second transfer-bias voltage having a polarity opposite to that of the developer to the image receiving medium P. The second transfer roller 139 applies the predetermined second transfer-voltage to the image receiving medium P, so that the primary transfer image formed on the transfer belt 136 can be secondarily transferred to the image receiving medium P, which is conveyed to the transfer belt 136 by the feeding unit 106, so as to form a secondary transfer image thereon.

The transfer position controlling unit 200 includes an encoding part 210 (see FIG. 6), a sensing part 230, and a controller 250.

As shown in FIG. 6, the encoding part 210 has a plurality of encoding elements 211 formed in a longitudinally spaced apart relation along one side of the transfer belt 136. Each of the plurality of encoding elements 211 includes a rectangular shaped slit or hole 211a, which penetrates the photoconductive layer 117 and the protective layer 120 of the transfer belt 136.

If the encoding elements 211 are too many in number, a detection signal generating period T of the sensing part 230 calculated according to the following equation (1) may become smaller than a predetermined first control margin M.

T=X /N±M (1)

Here, X is the period for one rotation of the transfer belt 136, and N is the number of the encoding elements 211.

To prevent this, the number of the encoding elements 211 can be set such that a value of X/N is not smaller than the first control margin M.

As shown in FIG. 7, the plurality of encoding elements 211 moves along a moving path, and the sensing part 230 is disposed on the moving path to detect the plurality of encoding elements 211. The sensing part 230 has a detecting sensor 231 such as a photo-interrupt sensor having a light emitting part 233 and a light receiving part 235 between which the encoding elements 211 are interposed.

The controller 250 is electrically connected to the various components of the printer 100 to control the operation of the printer 100, and has a microprocessor, which is mounted on a printed circuit board (not shown) fixed in the main body frame 110. A timer 252 is interfaced to the microprocessor.

The controller 250 controls a transfer start position at which respective developer images formed on the photoconductor 132 by the yellow, the magenta, the cyan and the black developing units 134, 137, 143 and 146 begin to be transferred and superimposed upon the transfer belt 136 on the basis of a detection signal generated by the detecting sensor 231 when the detecting sensor 231 first detects one of the encoding elements 211 after a printing command is input from the external device.

More specifically, the controller 250 controls a transfer start position for a first color developer image, for example, a yellow developer image, when the detecting sensor 231 first generates a detection signal after the printing command is input.

When the detecting sensor 231 first generates a detection signal after the printing command is input, the controller 250 determines that the transfer start position for the yellow developer image is the position of the transfer belt 136 corresponding to the encoding element 211 which caused the detecting sensor 231 to generate a detection signal. Accordingly, the controller 250 controls the LSU 176 and the yellow developing unit 134 to form a yellow electrostatic latent image and a yellow developer image at an image forming start position of the photoconductor 132 corresponding to the crosswise position of the transfer belt 136 determined as the transfer start position for the yellow developer image.

Then, when the transfer belt 136 and the photoconductor 132 rotate and thus the crosswise position of the transfer belt 136 determined as the transfer start position for the yellow developer image engages the image forming start position of the photoconductor 132 at a first transfer nip between the transfer belt 136 and the photoconductor 132, the controller 250 controls the first transfer-bias voltage applying unit to apply a first transfer-bias voltage to the first transfer roller 138. As a result, the yellow developer image formed on the photoconductor 132 is transferred to the transfer belt 136.

Next, the controller 250 determines whether a transfer control period C calculated according to the following equation (2) has passed from a time when the detecting sensor 231 first generates the detection signal, by using the timer 252.

C=X±M′ (2)

Here, X is the period for one rotation of the transfer belt 132, and M′ is a predetermined second control margin.

When it is determined that the transfer control period C has passed, the controller 250 determines as a transfer start position for the next color developer image, for example, a magenta developer image, a crosswise position of the transfer belt 136 corresponding to an encoding element 211 with which the detecting sensor 231 first generates a detection signal at a time when the transfer control period C passes. The controller 250 controls the LSU 176, the magenta developing unit 137, and the first transfer rollers 138 to form a magenta developer image from an image forming start position of the photoconductor 132 corresponding to the crosswise position of the transfer belt 136 determined as the transfer start position for the magenta developer image and then transfers the magenta developer image to the transfer belt 136 by the same method as that described above with respect to the yellow developer image.

After that, the controller 250 controls the transfer start positions for the remaining color developer images, for example, cyan and black developer images using the same method as that described above with respect to the yellow or magenta developer images, when the transfer control period C calculated according to the above equation (2) passes from a time when the transfer start position for the magenta developer image is determined.

As described above, the controller 250 determines the transfer start position at which the first color developer image, that is, the yellow developer image, is transferred to the transfer belt 136, as the position of the transfer belt 136 corresponding to an encoding element 211 with which the detecting sensor 231 first generates the detection signal after the printing command is input. Accordingly, the first color developer image, that is, the yellow developer image can be formed on the photoconductor 132 as soon as the detecting sensor 231 first generates the detection signal after the printing command is input, without waiting until the detecting sensor 30 generates a detection signal with the single position detecting hole 11, for example, for 1˜3 seconds which is the period for one rotation of the transfer belt, as in the conventional image forming device 1. Therefore, the standby time for forming the yellow developer image on the photoconductor 132 is reduced, so that the entire printing time is not delayed or irregular.

Also, every time an image is printed, the transfer start position for the yellow developer image varies according to the position of the transfer belt 136 corresponding to a first encoding element 211 with which the first detecting sensor 231 first generates a detection signal after the printing command is input. Accordingly, the transfer belt 136 is not repeatedly used at a position of the transfer belt 15 corresponding to the single position detecting hole 11, but instead is evenly used. As a result, the lifespan of the transfer belt 136 is increased.

As previously noted, with the color laser printer 100 having the transfer position controlling unit 200 according to the first exemplary embodiment of the present invention, the encoding part 210 has a plurality of encoding elements 211, each of which includes a slit or hole 211a, and a sensing part 230 that has a detecting sensor 231 such as a photo-interrupt sensor having a light emitting part 233 and a light receiving part 235. However, this should not be considered as limiting.

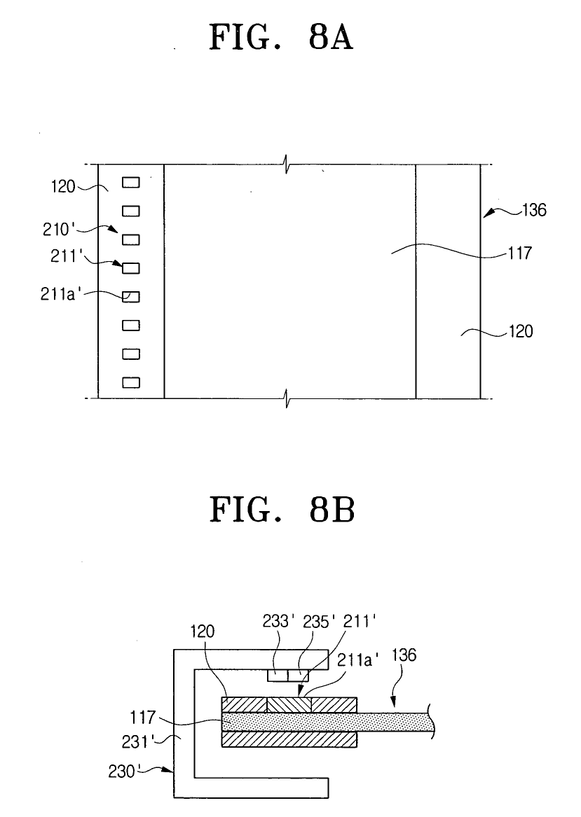

For instance, as shown in FIGS. 8A and 8B, the encoding part 210′ can have a plurality of encoding elements 211′, each of which includes a reflecting surface 211a′ and which are formed to be spaced apart from one another along one side of a surface of the transfer belt 136, and the sensing part 230′ can have a detecting sensor 231′ such as a photo-interrupt sensor having a light emitting part 233′ and a light receiving part 235′, which is disposed opposite to the reflecting surface 211a′ on a moving path of the reflecting surface 211a′.

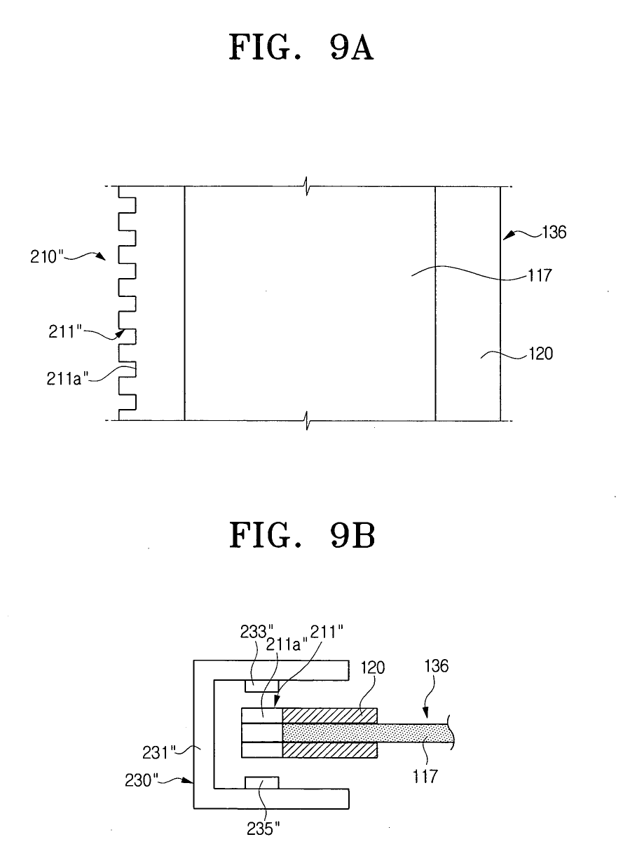

Also, as shown in FIGS. 9A and 9B, the encoding part 210″ can have a plurality of encoding elements 211″, each of which is includes a toothed opening 211a″ and which are formed to penetrate the photoconductive layer 117 and the protective layer 120 along one side of the transfer belt 136, and the sensing part 230″ can have a detecting sensor 231″ such as a photo-interrupt sensor having a light emitting part 233″ and a light receiving part 235″, which is disposed on a moving path of the toothed opening 211a″ with the toothed openings 211a″ interposed between the light emitting part 233″ and the light receiving part 235″.

The controller 250 of the transfer position controlling unit 200 according to the first exemplary embodiment of the present invention can determine whether the transfer belt 136 is in a normal condition at a period of time D for detecting abnormal condition of the transfer belt 136.

More specifically, the controller 250 determines whether the first detecting sensor 231 generates a detection signal every period D for detecting abnormal condition of the transfer belt 136. When the first detecting sensor 231 does not generate a detection signal, the controller 250 determines that the transfer belt 136 is in an abnormal condition, and controls a display part (not shown) of a control panel (not shown) connected to the controller 250 and/or a speaker (not shown) connected to the controller 250 to display a message and/or generate an alarm and thus to inform user of the abnormal condition while stopping a driving motor (not shown) which supplies a driving force to the driving roller 144 to rotate the transfer belt 136.

In an exemplary embodiment, the period of time D for detecting abnormal condition of the transfer belt 136 may be set as the same time duration as the detection signal generating period T of the detecting sensor 231 calculated according to the above equation (1).

Accordingly, the period of time D for detecting abnormal condition of the transfer belt 136 is greatly reduced as compared with a time until the position detecting sensor 30 generates a detection signal with the single position detecting hole 11 in the conventional image forming device 1, that is, the period for one rotation of the transfer belt (for example, three (3) seconds). As a result, an abnormal condition of the transfer belt 136 can be more quickly detected as compared with the conventional image forming device 1. Therefore, the transfer belt 136 is not damaged as a result of a delayed detection of abnormal conditions.

Referring again to FIG. 5, the fusing unit 140 fuses the secondary transfer image formed on the image receiving medium P by using heat and pressure so as to fix the secondary transfer image on the image receiving medium P. For this, the fusing unit 140 includes a heating roller 141 and a compression roller 142. The heating roller 141 heats the secondary transfer image on the image receiving medium P with high temperature in order to fuse the secondary transfer image onto the image receiving medium P. The compression roller 142 pressurizes the image receiving medium P to the heating roller 141.

The discharging unit 150 discharges the image receiving medium P to an output tray 167 after the secondary transfer image is fixed on the image receiving medium P by the fusing unit 140. The discharging unit 150 includes a discharging guide frame 123, a discharge roller 162, and a backup roller 161. The discharging guide frame 123 is disposed downstream of the fusing unit 140 so as to form the medium conveying and discharging path A. The discharge roller 162 and the backup roller 161 are rotatably fixed to the discharging guide frame 123 in the vicinity of a first discharging opening 163 that is formed at a vertical wall 168 of the main body frame 110 adjacent the output tray 167.

As previously noted, although the image forming device having the transfer position controlling apparatus according to the first exemplary embodiment of the present invention has been described with respect to a multi-path type color laser printer 100 having a single photoconductor 132, it is not limited to this particular type of image forming apparatus. For instance, the image forming device according to the first exemplary embodiment of the present invention is applicable to a single path type color laser printer including a transfer belt (not shown) that transfers developer images from a plurality of photoconductors (not shown) to an image receiving medium, by using the same structures and principles.

Also, although the image forming device having the transfer position controlling apparatus according to the first exemplary embodiment of the present invention has been described with respect to a color laser printer 100 that forms images on one surface of the image receiving medium P, it is not limited to this particular embodiment. For instance, the image forming device according to the first exemplary embodiment of the present invention is applicable to a color laser printer with a duplex printing function that forms required images on both surfaces of the image receiving medium P, by using the same structures and principles.

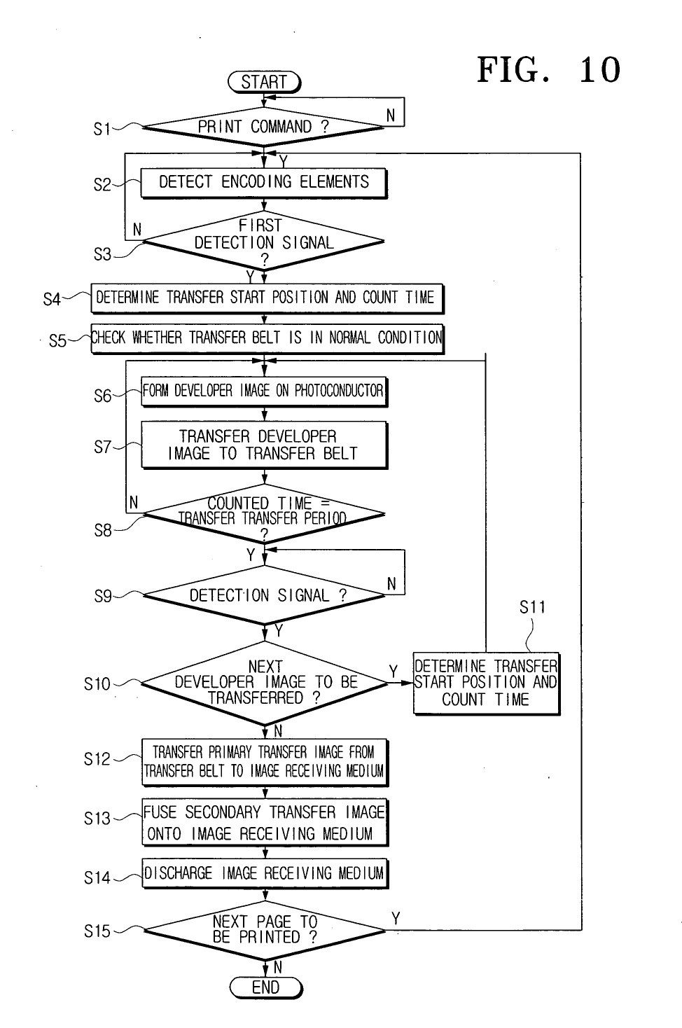

The operation of the color laser printer 100 according to the first exemplary embodiment of the present invention described above will now be described with reference to FIGS. 5 through 7, and 10.

Initially, when a printing command is input through an external device (such as a computer) or the control panel (S1), the transfer belt 136 begins to rotate, and the detecting sensor 231 detects the encoding elements 211 formed on the transfer belt 136, under control of the controller 250 (S2).

When the first detecting sensor 231 generates a first detection signal with the encoding elements 211 (S3), the controller 250 determines the transfer start position for a first color developer image, for example, a yellow developer image, to be transferred to the transfer belt 136, as a crosswise position of the transfer belt 136 that corresponds to an encoding element 211 with which the detecting sensor 231 generates the detection signal.

Further, the controller 250 resets the timer 252 when the detecting sensor 231 generates the first detection signal, and begins to count time by using the timer 252 (S4).

Also, at this time, the controller 250 begins to check whether the transfer belt 136 is in a normal condition through a separate algorithm (S5). That is, the controller 250 determines whether the detecting sensor 231 generates a detection signal when a period of time D for detecting an abnormal condition of the transfer belt 136, for example, a detection signal generating period T of the detecting sensor 231 calculated according to the above equation (1), passes. When the detecting sensor 231 does not generate a detection signal, the controller 250 determines that the transfer belt 136 is in an abnormal condition, and controls the display part and/or the speaker to display a message and/or generate an alarm and thus to inform user of the abnormal condition while stopping the driving motor for the driving roller 144 of the transfer belt 136.

Subsequently, the controller 250 controls the LSU 176 to form a yellow electrostatic latent image from an image forming start position of the photoconductor 132 corresponding to the crosswise position of the transfer belt 136 determined as the transfer start position for the yellow developer image according to an image signal input from the external device, and then controls the yellow developing unit 134 to develop the yellow electrostatic latent image formed on the photoconductor 132 with a yellow developer through the developing roller 147 so as to form a visible yellow developer image (S6).

When the crosswise position of the transfer belt 136 determined as the transfer start position for the yellow developer image arrives at the first transfer nip between the transfer belt 136 and the photoconductor 132, the controller 250 controls the first transfer-bias voltage applying unit to apply a first transfer-bias voltage having a polarity opposite to that of the developer to the first transfer rollers 138. As a result, the yellow developer image formed on the photoconductor 132 is transferred to the transfer belt 136 by the first transfer-bias voltage and pressure of the first transfer rollers 138 (S7).

After that, the controller 250 determines whether a transfer control period C calculated according to the above equation (2) passes from a time when the detecting sensor 231 generates the first detection signal, by using the timer 252 (S8). When it is determined that the transfer control period C calculated according to the above equation (2) has passed, the controller 250 determines whether the detecting sensor 231 generates a detection signal with the encoding elements 211 at a time when the transfer control period C has passed (S9).

As a result of the steps S8 and S9, when it is determined that the transfer control period C has passed and the detecting sensor 231 has generated the detection signal, the controller 250 determines whether there is a second color developer image, for example, a magenta developer image, to be formed (S10).

As a result of the step S10, when it is determined that there is the magenta developer image to be formed, the controller 250 determines as a transfer start position for the magenta developer image, a crosswise position of the transfer belt 136 corresponding to an encoding element 211 with which the detecting sensor 231 generates the detection signal at the step S9. Also, the controller 250 resets the timer 252 when the detecting sensor 231 generates the detection signal at the step S9, and begins to count time again through the timer 252 (S11).

After that, the controller 250 forms a magenta developer image from an image forming start position of the photoconductor 132 corresponding to the crosswise position of the transfer belt 136 determined as the transfer start position for the magenta developer image, transfers the image to the transfer belt 136, and determines whether there is another color developer image to be formed when the time counted by the reset timer 252 comes to the transfer control period C and the detecting sensor 231 generates a detection signal, in the same method as that in the steps S6 through S10 described above.

Then, the controller 250 carries out the same operations as those in the steps S6 through S10 for third and fourth developer images, for example, cyan and black developer images. As a result, a primary transfer image in which the yellow, magenta, cyan and black developer images are transferred and superimposed upon one another is formed on the transfer belt 136.

After that, when it is determined that there is no next color developer image to be formed at step S10, the controller 250 controls the second transfer-bias voltage applying unit to apply a second transfer-bias voltage to the second transfer roller 139 when a image receiving medium P arrives at the second nip between the transfer belt 136 and the second transfer roller 139 along the conveying guide frame 122 after being picked up by the pickup roller 107. As a result, the primary transfer image formed on the transfer belt 136 is transferred to the image receiving medium P by the second transfer-bias voltage and pressure from the second transfer roller 139 so as to form a secondary transfer image (S12).

The secondary transfer image formed on the image receiving medium P is fused onto the image receiving medium P by the heating roller 141 and the compression roller 142 of the fusing unit 140 (S13).

Subsequently, the image receiving medium P is guided along the discharging guide frame 123 constituting the medium conveying and discharging path A by the heating roller 141 and the compression roller 142, and discharged towards the output tray 167 by the discharge roller 162 and the backup roller 161 of the discharging unit 160 (S14).

After that, the controller 250 determines whether there is an additional page to be printed (S15). If there are the image signals for a next page, the operations of the steps S2 through S14 described above are performed with respect to the next image receiving medium P repeatedly until all of the image signals are printed.

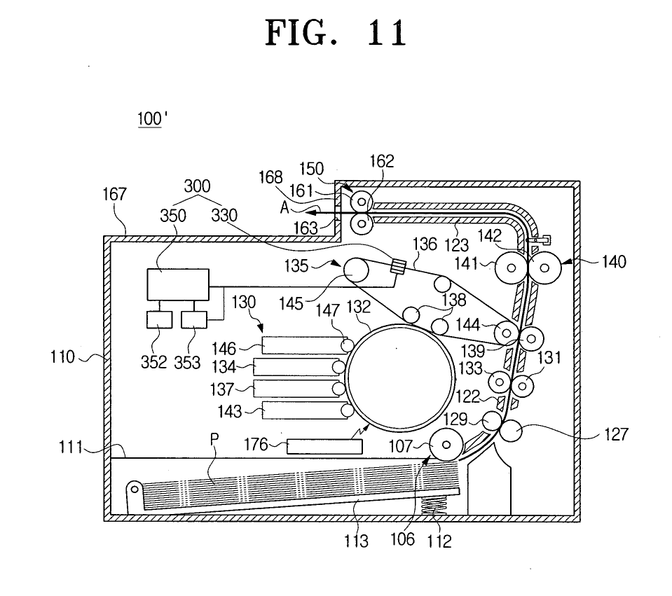

FIG. 11 schematically shows an image forming device having a transfer position controlling apparatus according to a second exemplary embodiment of the present invention.

The image forming device having the transfer position controlling apparatus according to the second exemplary embodiment of the present invention may be a color laser printer 100′ that prints and outputs data input from an external device, such as a computer. The present invention is not limited to the color laser printer 100′, however, and may be used with other image forming apparatuses.

The color laser printer 100′ includes a medium cassette 111, a feeding unit 106, an image forming unit 130, a transferring unit 135, a transfer position controlling unit 300, a fusing unit 140, and a discharging unit 150. Since the structure of the components of the color laser printer 100′ except for the transfer position controlling unit 300 is substantially the same as that of the color laser printer 100 of the first exemplary embodiment of the present invention, detailed descriptions and illustrations thereof are not repeated.

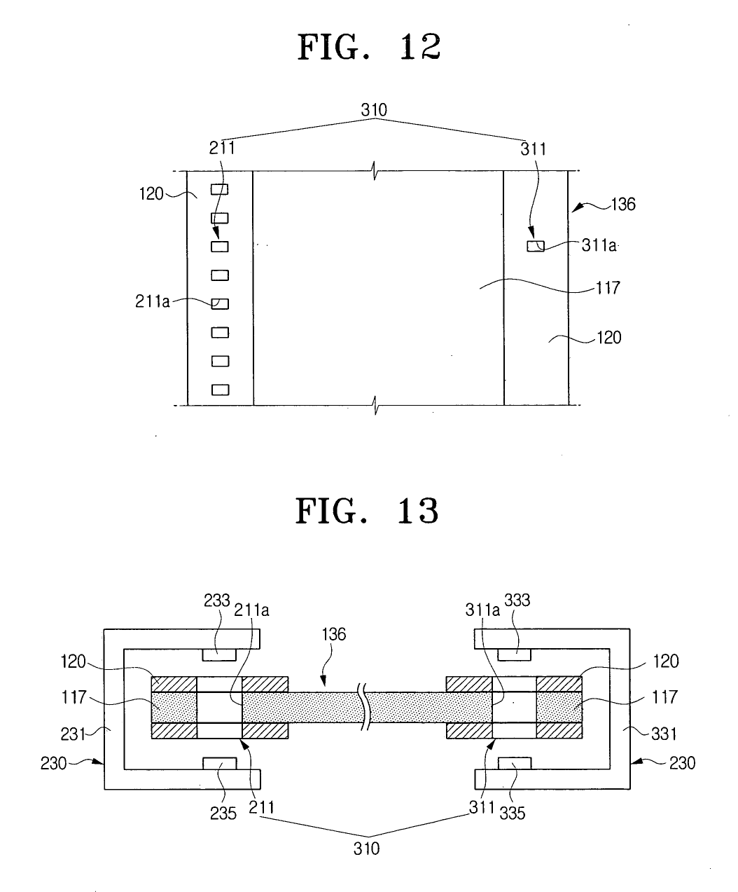

The transfer position controlling unit 300 includes an encoding part 310 (see FIG. 12), a sensing part 330, and a controller 350.

The encoding part 310 has a plurality of first encoding elements 211, and a second encoding element 311.

The plurality of first encoding elements 211 are formed in a longitudinally spaced apart relation along one side of the transfer belt 136.

Like as the encoding elements 211 of the transfer position controlling unit 200 of the first exemplary embodiment, each of the plurality of first encoding elements 211 includes a first rectangular shaped slit or hole 211a, which penetrates the photoconductive layer 117 and the protective layer 120 of the transfer belt 211 of the transfer belt 136.

The second encoding element 311 includes a second rectangular shaped slit or hole 311a, which is disposed at a predetermined point of the other side of the transfer belt 136 to have a moving path remote from that of the first encoding elements 211. The second rectangular shaped slit or hole 311a is also formed to penetrate the photoconductive layer 117 and the protective layer 120 of the transfer belt 136

Here, the second rectangular shaped slit or hole 311a is illustrated and explained as formed at the other side of the transfer belt 136 as the first encoding elements 211, but it can be formed at the same side of the transfer belt 136 with a moving path that is spaced apart from that of the first encoding elements 211.

As shown in FIG. 13, the sensing part 330 includes a first detecting sensor 231, and a second detecting sensor 331.

The first detecting sensor 231 is disposed on the moving path of the first encoding elements 211 to detect the first encoding elements 211. Like the detecting sensor 231 of the transfer position controlling unit 200 of the first exemplary embodiment, the first detecting sensor 231 includes a first photo-interrupt sensor having a first light emitting part 233 and a first light receiving part 235 between which the first encoding elements 211 are interposed.

The second detecting sensor 331 is disposed on the moving path of the second encoding element 311 to detect the second encoding element 311. The second detecting sensor 331 includes a second photo-interrupt sensor having a second light emitting part 333 and a second light receiving part 335 between which the second encoding elements 311 is interposed.

The controller 350 is electrically connected to the various units of the printer 100′ to control the operation of the printer 100′, and has a microprocessor, which is mounted on a printed circuit board (not shown) fixed in the main body frame 110. A memory 352 and a counting circuit 353 to count detection signals from the first detecting sensor 231 are interfaced to the microprocessor.

The controller 350 controls the transfer start positions which respective developer images formed on the photoconductor 132 by the yellow, the magenta, the cyan and the black developing units 134, 137, 143 and 146 begin to be transferred and superimposed upon the transfer belt 136, on the basis of a detection signal generated by the first detecting sensor 231 when the first detecting sensor 231 first detects one of the first encoding elements 211 after a printing command is input from the external device such as a computer, and a number of detection signals which the first detecting sensor 231 generates with the first encoding elements 211 from a time when the second detecting sensor 331 generates a detection signal with the second encoding element 311 through a time when the printing command is input.

More specifically, the controller 350 counts through the counting circuit 353, a number of detection signals generated by the first detecting sensor 231 from a time when the second detecting sensor 331 generates a detection signal while the transfer belt 135 rotates in an initiating operation of the printer 100′ when it is turned on.

When a printing command is input from the external device, the controller 350 determines as a transfer start position for a first color developer image, for example, a yellow developer image, a crosswise position of the transfer belt 136 corresponding to a first encoding element 211 with which the first detecting sensor 231 generates a detection signal at the time when the printing command is input. At the same time, the controller 350 stores a number of detection signals from the first detecting sensor 231 counted until the printing command is input, as a reference number of detection signals for determining the transfer start position in the memory 352.

Alternatively, at this time, the controller 350 can determine whether the crosswise position of the transfer belt 136 determined as the transfer start position for a first color developer image, that is, a yellow developer image overlaps with that in a previous printing, and if it overlaps, determines as a transfer start position for the yellow developer image, a crosswise position of the transfer belt 136 corresponding to a first encoding element 211 with which the first detecting sensor 231 generates a detection signal after a lapse of predetermined number of the detection signals from the time when the printing command is input.

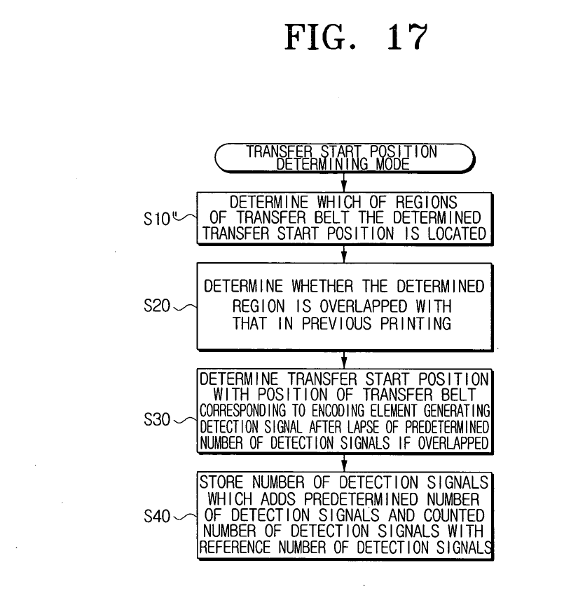

In this case, as shown in FIG. 17, the controller 350 divides the transfer belt 136 into a plurality of regions, and determines which of the plurality of regions of the transfer belt 136 the crosswise position of the transfer belt 136 determined as the transfer start position for the yellow developer image is located, on the basis of the number of detection signals generated by the first detecting sensor 231 counted from the time when the second detecting sensor 331 generates a detection signal through the time when the printing command is input (S10″). Then, the controller 350 determines whether the region of the transfer belt 136 determined that the crosswise position of the transfer belt 136 determined as the transfer start position for the yellow developer image is located overlaps the previous printing (S20). As a result of determination, if it does not overlap, the controller 350 determines as the transfer start position for the yellow developer image, the determined position, that is, the crosswise position of the transfer belt 136 corresponding to the first encoding element 211 with which the first detecting sensor 231 generates the detection signal at the time when the printing command is input. If it overlaps, the controller 350 determines as the transfer start position for the yellow developer image, a crosswise position of the transfer belt 136 corresponding to a first encoding element 211 with which the first detecting sensor 231 generates a detection signal after a lapse of predetermined number of the detection signals until the determined region of the transfer belt 136 is changed to another region (S30). At this time, the controller 350 can adjust the predetermined number of the detection signals so as to successively use the plurality of regions of the transfer belt 136 according to a predetermined order. After that, the controller 350 stores as a reference number of detection signals for determining transfer start position, a number of detection signals which adds the predetermined number of the detection signals and the number of detection signals generated by the first detecting sensor 231 counted from the time when the second detecting sensor 331 generates the detection signal through the time when the printing command is input, in the memory 352 (S40).

Subsequently, the controller 350 controls the LSU 176 and the yellow developing unit 134 respectively to form a yellow electrostatic latent image and a yellow developer image from an image forming start position of the photoconductor 132 corresponding to the crosswise position of the transfer belt 136 determined as the transfer start position for the yellow developer image.

When the transfer belt 136 and the photoconductor 132 rotate and thus the crosswise position of the transfer belt 136 determined as the transfer start position for the yellow developer image engages the image forming start position of the photoconductor 132 at the first transfer nip between the transfer belt 136 and the photoconductor 132, the controller 350 controls the first transfer-bias voltage applying unit to apply a first transfer-bias voltage to the first transfer rollers 138. As a result, the yellow developer image formed on the photoconductor 132 is transferred to the transfer belt 136.

After the yellow developer image is transferred to the transfer belt 136, the controller 350 determines whether a number of detection signals from the first detecting sensor 231 counted by the counting circuit 353 has reached the reference number of detection signals for determining transfer start position stored in the memory 352.

If the number has been reached, the controller 350 determines as a transfer start position for next color developer image, for example, a magenta developer image, a crosswise position of the transfer belt 136 corresponding to a first encoding element 211 with which the first detecting sensor 231 generates a detection signal at a time when the counted number of detection signals has reached the stored reference number of detection signals for determining transfer start position, and controls the LSU 176, the magenta developing unit 137, and the first transfer rollers 138 to form a magenta developer image from an image forming start position of the photoconductor 132 corresponding to the crosswise position of the transfer belt 136 determined as the transfer start position for the magenta developer image and then to transfer it to the transfer belt 136, in the same method as that for the yellow developer image described above.

After that, the controller 350 controls the transfer start positions for remaining developer images, for example, cyan and black developer images, in the same method as that for the yellow or magenta developer images described above, when the counted number of detection signals reaches the stored reference number of detection signals for determining a transfer start position.

As described above, the controller 350 controls the transfer start positions which the respective developer images formed on the photoconductor 132 begin to be transferred and superimposed upon the transfer belt 136, on the basis of the detection signal generated by the first detecting sensor 231 when the first detecting sensor 231 first detects one of the first encoding elements 211 after the printing command is input, and the number of detection signals which the first detecting sensor 231 generates with the first encoding elements 211 from the time when the second detecting sensor 331 generates the detection signal with the second encoding element 311 through the time when the printing command is input.

Accordingly, the first color developer image, that is, the yellow developer image can be formed on the photoconductor 132 as soon as the first detecting sensor 231 first generates the detection signal after the printing command is input, without waiting until the detecting sensor 30 generates a detection signal with the single position detecting hole 11, for example, for 1˜3 seconds which is the period for one rotation of the transfer belt, as in the conventional image forming device 1. Therefore, the standby time for forming the yellow developer image on the photoconductor 132 at an early time of printing is reduced, so that printing time is not delayed or irregular. Also, the transfer start positions for respective developer images are not fixed to a certain position of the transfer belt 15 at which the position detecting hole 11 is located as in the conventional image forming device 1, but vary according to the time when the first detecting sensor 231 first generates a detection signal after the printing command is input. Accordingly, the whole transfer belt 136 can be evenly used. As a result, the lifespan of the transfer belt 136 is increased.

As previously noted, according to the color laser printer 100′ having the transfer position controlling unit 300 according to the second exemplary embodiment of the present invention, the encoding part 310 has a plurality of first encoding elements 211, each of which includes a first slit or a first hole 211a′, and a second encoding element 311 which includes a second slit or a second hole 311a. Also, a sensing part 330 has first and second detecting sensors 231 and 331, which respectively include first and second photo-interrupt sensors having first and second light emitting parts 233 and 333 and first and second light receiving parts 235 and 335. However, this should not be considered as limiting.

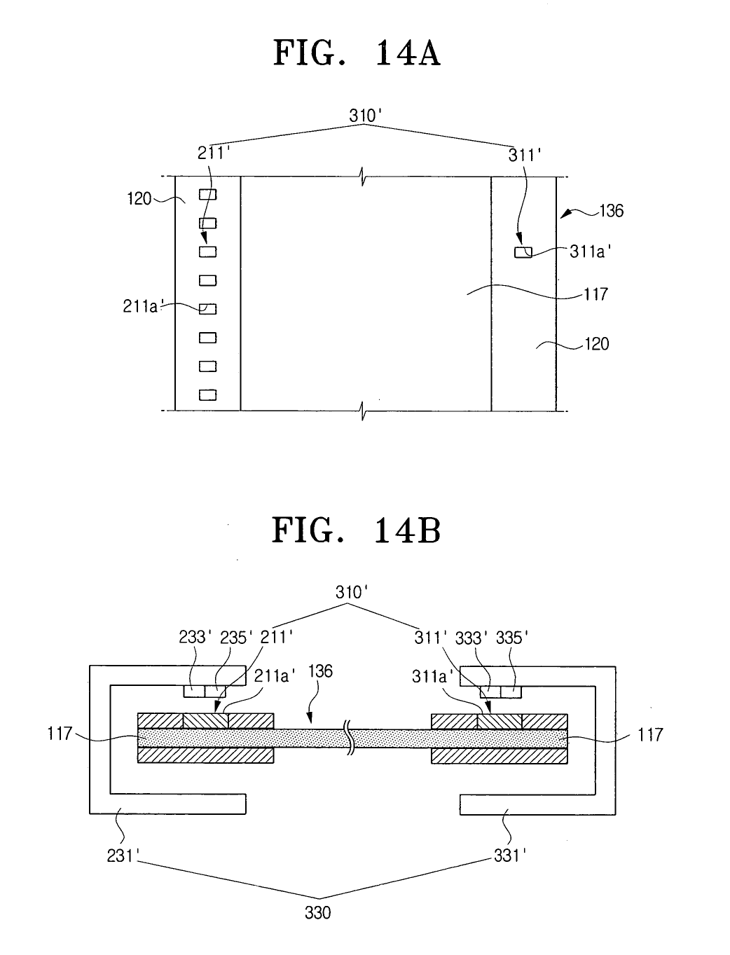

For instance, as shown in FIGS. 14A and 14B, the encoding part 310′ can have a plurality of first encoding elements 211′, each of which include a first reflecting surface 211a′ disposed on one side of a surface of the transfer belt 136, and a second encoding element 311′ which includes a second reflecting surface 311a′ disposed on the other side of the surface of the transfer belt 136. The sensing part 330′ can have a first detecting sensor 231′ such as a first photo-interrupt sensor having a first light emitting part 233′ and a first light receiving part 235′, which is disposed opposite to the first reflecting surfaces 211a′ on a moving path of the first reflecting surfaces 211a′, and a second detecting sensor 331′ such as a second photo-interrupt sensor having a second light emitting part 333′ and a second light receiving part 335′, which is disposed opposite to the second reflecting surface 311a′ on a moving path of the second reflecting surface 311a′.

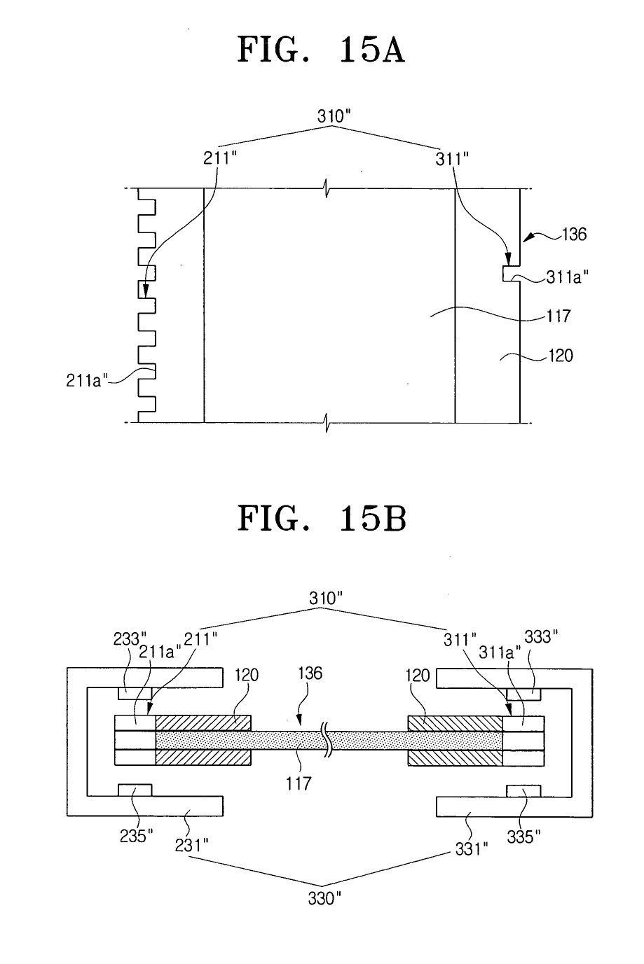

Also, as shown in FIGS. 15A and 15B, the encoding part 310″ can have a plurality of first encoding elements 211″, each of which includes a toothed opening 211a″ and which are formed to penetrate the photoconductive layer 117 and the protective layer 120 along one side of the transfer belt 136, and a second encoding element 311″ which includes an opening 211a″ which penetrates the photoconductive layer 117 and the protective layer 120 at the other side of the transfer belt 136. The sensing part 330″ can have a first detecting sensor 231″ and a second detecting sensor 331″. The first detecting sensor 231″ includes a first photo-interrupt sensor having a first light emitting part 233″ and a first light receiving part 235″, which is disposed on a moving path of the toothed openings 211a″ with the toothed openings 211a″ interposed between the first light emitting part 233″ and the first light receiving part 235″. The second detecting sensor 331″ includes a second photo-interrupt sensor having a second light emitting part 333″ and a second light receiving part 335″) which is disposed on a moving path of the openings 311a″ with the openings 311a″ interposed between the second light emitting part 333″ and the second light receiving part 335″.

Alternatively, the controller 350 of the transfer position controlling unit 300 according to the second exemplary embodiment of the present invention can determine whether the transfer belt 136 is in a normal condition every period of time D for detecting abnormal condition of the transfer belt 136. Since the operation of determining whether the transfer belt 136 is in the normal condition is the same as that of the color laser printer 100 of the first exemplary embodiment of the present invention, detailed descriptions and illustrations thereof are not repeated.

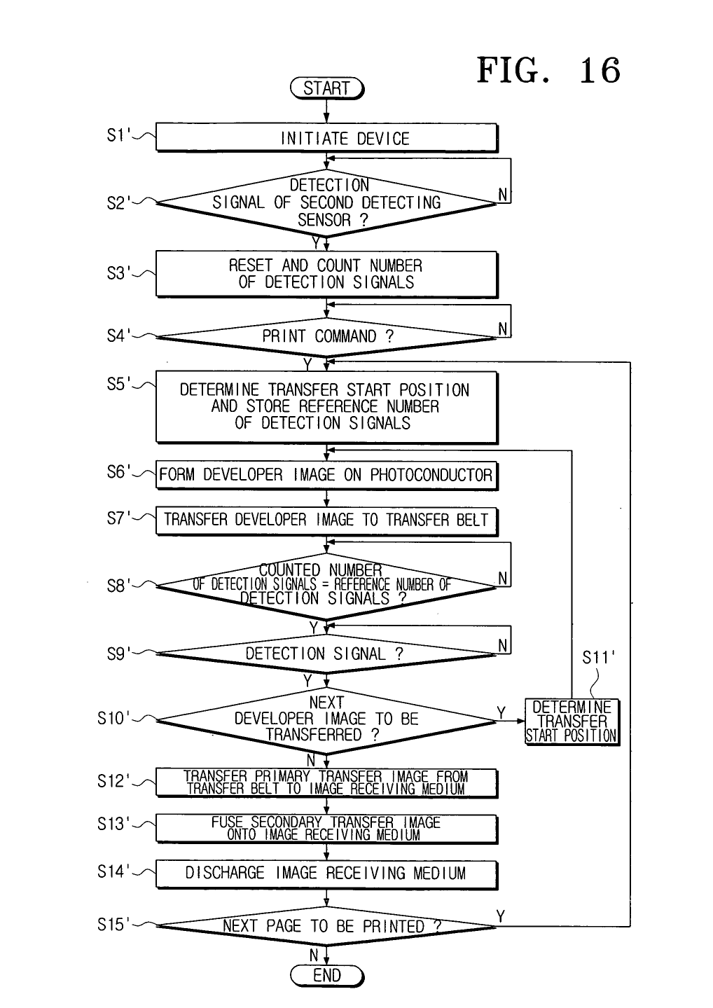

The operation of the color laser printer 100′ according to the second exemplary embodiment of the present invention described above will now be described with reference to FIGS. 11 through 13, and 16.

Initially, when the color laser printer 100′ is turned on, the controller 350 carries out an initiating operation that turns on a heater (not shown) disposed in the heating roller 141 of the fusing unit 140 to heat the heating roller 141 and drives the driving motor for driving the driving roller 144 to rotate the trans belt 136 (S1′).

While the transfer belt 136 rotates, the controller 350 determines whether the second detecting sensor 331 generates a detection signal with the second encoding element 311 (S2′).

When it is determined that the second detecting sensor 331 generates the detection signal at the step S2′, the controller 350 resets the counting circuit 353 and counts a number of detection signals generated by the first detecting sensor 231 through the counting circuit 353 (S3′).

At this time, if the transfer belt 136 rotates once more and thus the second detecting sensor 331 generate again a detection signal, the controller 350 resets the counting circuit 353 and counts again a number of detection signals generated by the first sensor 231 through the counting circuit 353.

When a printing command is input from an external device such as a computer (S4′), the controller 350 determines as a transfer start position for the first color developer image, for example, a yellow developer image, a crosswise position of the transfer belt 136 corresponding to a first encoding element 211 with which the first detecting sensor 231 generates a detection signal at a time when the printing command is input. Also, the controller 350 stores a number of detection signals from the first detecting sensor 231 counted until the printing command is input, as a reference number of detection signals for determining a transfer start position in the memory 352 (S5′).

Alternatively, at this time, to evenly use the whole transfer belt 135 without using the portions used in a previous printing operation, the controller 350 can determine whether the crosswise position of the transfer belt 136 determined as the transfer start position for a first color developer image, that is, a yellow developer image, overlaps the previous printing, and if it overlaps, determine as a transfer start position for the yellow developer image, a crosswise position of the transfer belt 136 corresponding to a first encoding element 211 with which the first detecting sensor 231 generates a detection signal after a lapse of a predetermined number of the detection signals from the time when the printing command is input, and stores a number of detection signals from the first detecting sensor 231 counted till then, as a reference number of detection signals for determining a transfer start position in the memory 352, as described with reference to FIG. 17.

Subsequently, the controller 350 controls the LSU 176 to form a yellow electrostatic latent image from an image forming start position of the photoconductor 132 corresponding to the crosswise position of the transfer belt 136 determined as the transfer start position for the yellow developer image, according to image signals input from the external device.

Then, the controller 350 controls the developing roller 147 of the yellow developing unit 134 to develop the yellow electrostatic latent image formed on the photoconductor 132 with a yellow developer and thus to form a visible yellow developer image (S6′).

When the transfer belt 136 and the photoconductor 132 rotate and thus the crosswise position of the transfer belt 136 determined as the transfer start position for the yellow developer image engages the image forming start position of the photoconductor 132 at the first transfer nip between the transfer belt 136 and the photoconductor 132, the controller 350 controls the first transfer-bias voltage applying unit to apply a first transfer-bias voltage to the first transfer rollers 138. As a result, the yellow developer image formed on the photoconductor 132 is transferred to the transfer belt 136 (S7′).

After the yellow developer image is transferred to the transfer belt 136, the controller 350 determines whether a number of detection signals from the first detecting sensor 231 counted by the counting circuit 353 has reached the reference number of detection signals for determining a transfer start position stored in the memory 352 (S8′), and as a result of the determination, if the reference number is reached, determines whether the first detecting elements 231 generates a detection signal with a first encoding element 211 at a time when reached (S9′).

When it is determined that the counted number of detection signals has reached the stored reference number of detection signals at the step S8′ and the first detecting elements 231 has generated a detection signal at the step S9′, the controller 350 determines whether there is a second color developer image, for example, a magenta developer image, to be formed (S10′).

As a result of the step S10′, if there is the magenta developer image to be formed, the controller 350 determines as a transfer start position for the magenta developer image, a crosswise position of the transfer belt 136 corresponding to a first encoding element 211 with which the first detecting sensor 231 generates the detection signal at the step S9′ (S11′). The controller 350 then controls the LSU 176, the magenta developing unit 137, and the first transfer rollers 138 to form a magenta developer image from an image forming start position of the photoconductor 132 corresponding to the crosswise position of the transfer belt 136 determined as the transfer start position for the magenta developer image, transfer the image to the transfer belt 136. The controller next determines whether there are additional color developer images to be formed, in the same method as that of the steps S6′ through S10′ described above.

After that, the controller 350 carries out the same operations as that of the steps S6′ through S10′ for the third and fourth developer images, for example, cyan and black developer images. As a result, a primary transfer image in which the yellow, the magenta, the cyan and the black developer images are transferred and superimposed upon one other is formed on the transfer belt 136.

And then, like the steps S12 through S14 of the first exemplary embodiment, the primary transfer image formed on the transfer belt 136 is transferred onto the image receiving medium P so as to form a secondary transfer image (S12′), and then fused onto the image receiving medium P by the heating roller 141 and the compression roller 142 of the fusing unit 140 (S13′). Subsequently, the image receiving medium P is discharged towards the output tray 167 by the discharge roller 162 and the backup roller 161 of the discharging unit 160 (S14′).

After that, the controller 250 determines whether there are additional pages to be printed (S15′). If there are additional pages to be printed, the operations of the steps S5′ through S14′ described above are performed with respect to the following image receiving medium P repeatedly until all of the pages are printed.

According to the exemplary embodiments of the present invention as described above, the transfer position controlling apparatus, the image forming device having the same and the transfer position controlling method thereof controls the transfer start position at which the developer images, particularly, the first color developer image, is transferred to the transfer belt, on the basis of the detection signal which is generated by the first detecting sensor, that is, the position of the transfer belt corresponding to the encoding element with which the first detecting sensor first generates the detection signal after the printing command is input. Accordingly, a plurality of developer images, particularly, the first developer image, can be formed on the photoconductor as soon as the first detecting sensor generates a detection signal after the printing command is input, without waiting until the detecting sensor generates the detection signal with the single position detecting hole, for example, for 1˜3 seconds which is the period for one rotation of the transfer belt, as in the conventional image forming device. Therefore, the standby time for forming the first developer image on the photoconductor is reduced, so that printing time is not delayed or irregular. Further, the transfer start position for respective developer images, particularly, the first color developer image, is not fixed to the position of the transfer belt at which the position detecting hole is located as in a conventional image forming device, but varies according to the time when the first detecting sensor first generates a detection signal after the printing command is input. Accordingly, the transfer belt does not have a certain portion which is repeatedly used, but instead is evenly used. As a result, the lifespan of the transfer belt is increased.

Also, according to the exemplary embodiments of the present invention as described above, the transfer position controlling apparatus, the image forming device having the same and the transfer position controlling method thereof can determine the period for detecting abnormal condition of the transfer belt with the detection signal generating period of the first detecting sensor. Accordingly, the period of time for detecting abnormal condition of the transfer belt is greatly reduced as compared with the time until the position detecting sensor generates the detection signal with the single position detecting hole in a conventional image forming device, that is, the period for one rotation of the transfer belt (for example, 3 seconds). Thus, an abnormal condition of the transfer belt can be more quickly detected as compared with the conventional image forming device. As a result, the transfer belt is not damaged by a delay in detecting an abnormal condition.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A transfer position controlling apparatus for an image forming device, comprising:
an encoding part having a plurality of first encoding elements formed in a longitudinally spaced apart relation on a transfer belt, the plurality of first encoding elements moving along a moving path when the transfer belt rotates;
a sensing part having a first detecting sensor to detect the plurality of first encoding elements, the sensing part being disposed on the moving path of the plurality of first encoding elements; and
a controller to determine a transfer start position at which a developer image is transferred to the transfer belt on the basis of a detection signal generated by the first detecting sensor when the first detecting sensor detects one of the plurality of first encoding elements after a printing command is input, and to control the device to form a developer image on the photoconductor according to the transfer start position.

2. The transfer position controlling apparatus of claim 1, wherein the plurality of first encoding elements comprises one of:
a plurality of first holes penetrating the transfer belt, the plurality of first holes being spaced apart from one another along one side of the transfer belt;
a plurality of first reflecting surfaces spaced apart from one another along one side of a surface of the transfer belt; and
a plurality of first toothed openings spaced apart from one another along one side of the transfer belt.

3. The transfer position controlling apparatus of claim 1, wherein the first detecting sensor comprises a first photo-interrupt sensor having a first light emitting part and a first light receiving part.

4. The transfer position controlling apparatus of claim 1,
wherein the controller superimposes a plurality of developer images on the transfer belt, and
wherein the controller determines as a transfer start position for a first developer image, a position of the transfer belt corresponding to a first encoding element detected after the printing command is input, and determines as transfer start positions for the remaining developer images positions of the transfer belt corresponding to first encoding elements detected by the first detecting sensor when a transfer control period C passes from a time when the first detecting sensor first generates the detection signal after the printing command is input, wherein the transfer control period C is calculated according to the following equation:
C=X±M′,
where X is a period for one rotation of the transfer belt, and M′ is a second control margin.

5. The transfer position controlling apparatus of claim 1, wherein the controller periodically determines whether the first detecting sensor generates a detection signal to detect abnormal condition of the transfer belt, and controls the transfer belt to stop the operation thereof when the first detecting sensor does not generate a detection signal.

6. The transfer position controlling apparatus of claim 5, wherein the period for detecting abnormal condition of the transfer belt comprises a detection signal generating period T of the first detecting sensor, wherein the detection signal generating period T is calculated according to the following equation:
T=X/N±M,
where X is a period for one rotation of the transfer belt, N is a number of the first encoding elements, and M is a first control margin.

7. The transfer position controlling apparatus of claim 2,
wherein the encoding part further comprises a second encoding element disposed on the transfer belt to have a moving path separate from the moving path of the first encoding elements, and
wherein the sensing part further comprises a second detection sensor disposed on the moving path of the second encoding element to detect the second encoding element.

8. The transfer position controlling apparatus of claim 7,
wherein the second encoding element comprises one of a second hole penetrating the transfer belt, a second reflecting surface disposed on the transfer belt, and a second toothed opening disposed on the transfer belt, and
wherein the second detecting sensor comprises a second photo-interrupt sensor having a second light emitting part and a second light receiving part.

9. The transfer position controlling apparatus of claim 7,
wherein the controller superimposes a plurality of developer images on the transfer belt, and
wherein the controller:
counts a number of detection signals generated by the first detecting sensor from a time when the second detecting sensor generates a detection signal through a time when the printing command is input, so as to store the counted number of detection signals as a reference number of detection signals for determining a transfer position,
determines as a transfer start position for a first developer image, a position of the transfer belt corresponding to a first encoding element detected after the printing command is input, and
counts a number of detection signals generated by the first detecting sensor from a time when the second detecting sensor again generates a detection signal, so as to determine as transfer start positions for the remaining developer images positions of the transfer belt corresponding to first encoding elements detected when the counted number of detection signals reaches the reference number of detection signals.

10. The transfer position controlling apparatus of claim 9,
wherein the controller determines whether the position of the transfer belt determined as the transfer start position for the first developer image overlaps with the position of the transfer belt in previous printing, and, if the determined position of the transfer belt overlaps the position of the transfer belt in the previous printing, determines as a transfer start position for the first developer image a position of the transfer belt corresponding to a first encoding element detected after a lapse of a predetermined number of the detection signals from the time when the printing command is input.

11. The transfer position controlling apparatus of claim 10, wherein the controller:
determines which of a plurality of regions of the transfer belt the position of the transfer belt determined as the transfer start position for a first developer image is located, on the basis of the number of detection signals generated by the first detecting sensor counted from the time when the second detecting element is detected through the time when the printing command is input,
determines whether the region of the transfer belt determined as the transfer start position for the first developer image overlaps the region used in the previous printing, and
if the determined region overlaps the region used in the previous printing, determines as a transfer start position for the first developer image a position of the transfer belt corresponding to a first encoding element detected after a lapse of a predetermined number of detection signals so that the transfer belt is moved to another region.

12. The transfer position controlling apparatus of claim 11,
wherein the reference number of detection signals for determining a transfer position comprises a number of detection signals which adds the predetermined number of detection signals and the number of detection signals generated by the first detecting sensor counted from the time when the second detecting element is detected to the time when the printing command is input.

13. The transfer position controlling apparatus of claim 11,
wherein the controller adjusts the predetermined number of the detection signals so as to successively use the plurality of regions of the transfer belt according to a predetermined order.

14. An image forming device comprising:
a photoconductor to form a developer image;
a transfer belt to transfer the developer image from the photoconductor to the transfer belt;
a transfer position controlling unit to control a transfer position at which the developer image is transferred to the transfer belt,
wherein the transfer position controlling unit comprises:
an encoding part having a plurality of first encoding elements formed in a longitudinally spaced apart relation on a transfer belt, the plurality of first encoding elements moving along a moving path when the transfer belt rotates;
a sensing part having a first detecting sensor for detecting the plurality of first encoding elements, the sensing part being disposed on the moving path of the plurality of first encoding elements; and
a controller to determine a transfer start position at which a developer image is transferred to the transfer belt on the basis of a detection signal generated by the first detecting sensor when the first detecting sensor detects one of the plurality of first encoding elements after a printing command is input, and to control the device to form a developer image on the photoconductor according to the transfer start position.

15. The image forming device of claim 14, wherein the plurality of first encoding elements comprises one of:
a plurality of first holes penetrating the transfer belt, the plurality of first holes being spaced apart from one another along one side of the transfer belt;
a plurality of first reflecting surfaces spaced apart from one another along one side of a surface of the transfer belt; and
a plurality of first toothed openings spaced apart from one another along one side of the transfer belt.

16. The image forming device of claim 14, wherein the first detecting sensor comprises a first photo-interrupt sensor having a first light emitting part and a first light receiving part.

17. The image forming device of claim 14,
wherein the controller superimposes a plurality of developer images on the transfer belt, and
wherein the controller determines as a transfer start position for a first developer image, a position of the transfer belt corresponding to a first encoding element detected after the printing command is input, and determines as transfer start positions for the remaining developer images positions of the transfer belt corresponding to first encoding elements detected by the first detecting sensor when a transfer control period C passes from a time when the first detecting sensor first generates the detection signal after the printing command is input, wherein the transfer control period C is calculated according to the following equation:
C=X±M′
where X is a period for one rotation of the transfer belt, and M′ is a second control margin.

18. The image forming device of claim 14, wherein the controller periodically determines whether the first detecting sensor generates a detection signal to detect abnormal condition of the transfer belt, and controls the transfer belt to stop the operation thereof when the first detecting sensor does not generate a detection signal.

19. The image forming device of claim 18, wherein the period for detecting abnormal condition of the transfer belt comprises a detection signal generating period T of the first detecting sensor, wherein the detection signal generating period T is calculated according to the following equation:
T=X/N±M,
where X is a period for one rotation of the transfer belt, N is a number of the first encoding elements, and M is a first control margin.

20. The image forming device of claim 15,
wherein the encoding part further comprises a second encoding element disposed on the transfer belt to have a moving path separate from the moving path of the first encoding elements, and
wherein the sensing part further comprises a second detection sensor disposed on the moving path of the second encoding element to detect the second encoding element.

21. The image forming device of claim 20,
wherein the second encoding element comprises one of a second hole penetrating the transfer belt, a second reflecting surface disposed on the transfer belt, and a second toothed opening disposed on the transfer belt, and
wherein the second detecting sensor comprises a second photo-interrupt sensor having a second light emitting part and a second light receiving part.

22. The image forming device of claim 20,
wherein the controller superimposes a plurality of developer images on the transfer belt, and
wherein the controller:
counts a number of detection signals generated by the first detecting sensor from a time when the second detecting sensor generates a detection signal through a time when the printing command is input, so as to store the counted number of detection signals as a reference number of detection signals for determining a transfer position,
determines as a transfer start position for a first developer image, a position of the transfer belt corresponding to a first encoding element detected when the printing command is input, and
counts a number of detection signals generated by the first detecting sensor from a time when the second detecting sensor again generates a detection signal, so as to determine as transfer start positions for the remaining developer images positions of the transfer belt corresponding to first encoding elements detected when the counted number of detection signals reaches the reference number of detection signals.

23. The image forming device of claim 22,
wherein the controller determines whether the position of the transfer belt determined as the transfer start position for the first developer image overlaps with the position of the transfer belt in previous printing, and, if the determined position of the transfer belt overlaps the position of the transfer belt in the previous printing, determines as a transfer start position for the first developer image a position of the transfer belt corresponding to a first encoding element detected after a lapse of a predetermined number of the detection signals from the time when the printing command is input.

24. The image forming device of claim 23,
wherein the controller:
determines which of a plurality of regions of the transfer belt the position of the transfer belt determined as the transfer start position for a first developer image is located, on the basis of the number of detection signals generated by the first detecting sensor counted from the time when the second detecting element is detected through the time when the printing command is input,
determines whether the region of the transfer belt determined as the transfer start position for the first developer image overlaps the region used in the previous printing, and
if the determined region overlaps the region used in the previous printing, determines as a transfer start position for the first developer image a position of the transfer belt corresponding to a first encoding element detected after a lapse of a predetermined number of detection signals so that the transfer belt is moved to another region.

25. The image forming device of claim 24,
wherein the reference number of detection signals for determining a transfer position comprises a number of detection signals which adds the predetermined number of detection signals and the number of detection signals generated by the first detecting sensor counted from the time when the second detecting element is detected to the time when the printing command is input.

26. The image forming device of claim 25,
wherein the controller adjusts the predetermined number of the detection signals so as to successively use the plurality of regions of the transfer belt according to a predetermined order.

27. A transfer position controlling method of an image forming device comprising the steps of:
detecting a plurality of first encoding elements formed on a transfer belt by a first detecting sensor when a printing command is input; and
controlling a transfer start position at which a developer image is transferred to the transfer belt, on the basis of the time when the first detecting sensor first generates a detection signal with one of the plurality of the first encoding elements after the printing command is input.

28. The transfer position controlling method of claim 27, wherein the step of controlling the transfer start position comprises:
determining the transfer start position on the basis of a detection signal generated by the first detecting sensor when the first detecting sensor detects one of the plurality of the first encoding elements after the printing command is input;
beginning to form a developer image at an image forming position of the photoconductor corresponding to the determined transfer start position of the transfer belt; and
transferring the developer image formed on the photoconductor to the transfer belt when the determined transfer start position of the transfer belt arrives at the photoconductor.

29. The transfer position controlling method of claim 28, wherein the step of determining the transfer start position comprises:
determining as a transfer start position for a first developer image, a position of the transfer belt corresponding to a first encoding element detected after the printing command is input; and
determining as transfer start positions for the remaining developer images positions of the transfer belt corresponding to first encoding elements detected by the first detecting sensor when a transfer control period C passes from a time when the first detecting sensor first generates the detection signal after the printing command is input, wherein the transfer control period C is calculated according to the following equation:
C=X±M′,
where X is a period for one rotation of the transfer belt, and M′ is a second control margin.

30. The transfer position controlling method of claim 27, further comprising the step of
determining whether the transfer belt is in a normal condition.

31. The transfer position controlling method of claim 30, wherein the step of determining whether the transfer belt is in a normal condition comprises:
periodically determining whether the first detecting sensor generates a detection signal for detecting abnormal condition of the transfer belt; and
stopping the transfer belt if the first detecting sensor does not generate the detection signal.

32. The transfer position controlling method of claim 31, wherein the period for detecting abnormal condition of the transfer belt comprises a detection signal generating period T of the first detecting sensor, wherein the detection signal generating period T is calculated according to the following equation:
T=X/N±M,
wherein X is a period for one rotation of the transfer belt, N is a number of the first encoding elements, and M is a first control margin.

33. A transfer position controlling method of an image forming device comprising the steps of:
initiating the image forming device;
detecting a second encoding element formed on a transfer belt with a second detecting sensor while initiating the image forming device;
counting a number of detection signals generated by a first detecting sensor when the first detecting sensor detects a plurality of first encoding elements formed on the transfer belt, from a time when the second detecting element is detected;
determining whether a printing command is input;
controlling a transfer start position at which a first developer image of a plurality of developer images is transferred to the transfer belt on the basis of a position of the transfer belt corresponding to a first encoding element detected when the printing command is input; and
controlling transfer start positions at which the remaining developer images of the plurality of developer images are transferred to the transfer belt on the basis of the number of detection signals generated by the first detecting sensor counted from the time when the second detecting element is detected through a time when the printing command is input.

34. The transfer position controlling method of claim 33, wherein the step of initiating the image forming device comprises rotating the transfer belt.

35. The transfer position controlling method of claim 33, wherein the step of counting the number of detection signals comprises:
resetting a number of detection signals when the second detecting element is detected; and
counting the detection signals generated by the first detecting sensor.

36. The transfer position controlling method of claim 33, wherein the step of controlling the transfer start position for the first developer image comprises:
determining as a transfer start position for a first developer image, a position of the transfer belt corresponding to a first encoding element detected after the printing command is input; and
forming a first developer image at an image forming position of the photoconductor corresponding to the determined position of the transfer belt; and
transferring the first developer image formed on the photoconductor to the transfer belt when the determined position of the transfer belt arrives at the photoconductor.

37. The transfer position controlling method of claim 36, wherein the step of controlling the transfer start positions for the remaining developer images comprises:
storing as a reference number of detection signals for determining a transfer position a number of detection signals generated by the first detecting sensor counted from the time when the second detecting element is detected through the time when the printing command is input;
counting again a number of detection signals generated by the first detecting sensor from a time when the second detecting sensor generates again a detection signal;
determining as transfer start positions at which the remaining developer images are transferred to the transfer belt, respectively, positions of the transfer belt corresponding to first encoding elements detected after the counted number of detection signals reaches the stored reference number of detection signals;
forming the remaining developer images from image forming positions of the photoconductor corresponding to the determined positions of the transfer belt, respectively; and
transferring the remaining developer images formed on the photoconductor to the transfer belt when the determined positions of the transfer belt arrive at the photoconductor, respectively.

38. The transfer position controlling method of claim 37, wherein the step of determining as the transfer start position at which the first developer image is transferred to the transfer belt comprises:
determining whether the position of the transfer belt determined as the transfer start position for the first developer image overlaps with the position of the transfer belt in previous printing; and
if the determined position of the transfer belt overlaps the position of the transfer belt in the previous printing, determining as a transfer start position for the first developer image a position of the transfer belt corresponding to a first encoding element detected after a lapse of a predetermined number of the detection signals from the time when the printing command is input.

39. The transfer position controlling method of claim 38, wherein the determining whether the position of the transfer belt determined as the transfer start position for the first developer image is overlapped comprises:
determining which of a plurality of regions of the transfer belt the position of the transfer belt determined as the transfer start position for a first developer image is located, on the basis of the number of detection signals generated by the first detecting sensor counted from the time when the second detecting element is detected through the time when the printing command is input;
determining whether the region of the transfer belt determined as the transfer start position for the first developer image overlaps the region used in the previous printing; and
if the determined region overlaps the region used in the previous printing, determining as a transfer start position for the first developer image a position of the transfer belt corresponding to a first encoding element detected after a lapse of a predetermined number of detection signals so that the transfer belt is moved to another region,
wherein the predetermined number of the detection signals comprises a number of detection signals generated by the first detecting sensor until the determined region of the transfer belt is changed to another region.

40. The transfer position controlling method of claim 39,
wherein the reference number of detection signals for determining a transfer position comprises a number of detection signals which adds the predetermined number of detection signals and the number of detection signals generated by the first detecting sensor counted from the time when the second detecting element is detected to the time when the printing command is input.
